(19) United States
(12) Patent Application Publication
(10) Pub. No.: US 2024/0127704 A1
(43) Pub. Date: Apr. 18, 2024

(54) SYSTEMS AND METHODS FOR GENERATING CONTENT THROUGH AN INTERACTIVE SCRIPT AND 3D VIRTUAL CHARACTERS

(71) Applicant: Talespin Reality Labs, Inc., CULVER CITY, CA (US)

(72) Inventors: Cornelis Joost Adrianus DE CLOE, HOEF EN HAAG (NL); Tom VAN DER SCHAAF, AMSTERDAM (NL)

(73) Assignee: Talespin Reality Labs, Inc., CULVER CITY, CA (US)

(21) Appl. No.: 18/277,395

(22) PCT Filed: Feb. 15, 2022
(86) PCT No.: PCT/IB2022/051336

§ 371 Date: Aug. 16, 2023

(30) Foreign Application Priority Data
Feb. 17, 2021 (NL) 2027576

(51) Int. Cl. G09B 5/06

(52) U.S. Cl. CPC G09B 5/065

(57) ABSTRACT

Certain embodiments of the present disclosure are relating to devices, systems, and/or methods that may be used for generating content with an interactive script and 3D virtual characters. Exemplary systems, method and applications are disclosed that are configured to support creation and play-back of 3D interactive content around conversations and interactions between users and 3D virtual characters.

### REFERENCES

Montgomery, Joel R. Goal-Based Learning: Conceptual Design “Jump-Start” Workbook, Andersen Worldwide, SC., St. Charles, IL. August 1996) is herein incorporated by reference in its entirety.

### FIELD

The present disclosure generally relates to devices, systems, and/or methods that may be used for generating content with an interactive script and 3D virtual characters. The present disclosure is also related to devices, systems, and/or methods that generally relate to achieving the measurement of a user's goal through computer-generated interactions with virtual characters. The present disclosure is also related to devices, systems and/or methods that enable content creators to manipulate packaged 3D assets and combine them with logic to send both together as a data stream to virtual content.

### BACKGROUND

The discussion of the background of the present disclosure is included to explain the context of the disclosed embodiments. This discussion is not to be taken as an admission that the material referred to was published, known or part of the common general knowledge at the priority date of the embodiments and claims presented in this disclosure.

There is a growing need for devices, systems, and/or methods that permit content creators to design and develop interactive goal-based content. The use of interactive scriptwriting and 3D virtual characters enables a measurable social interaction in lieu of requiring in-person observation. Traditional learning content uses methods and mediums like textbooks, oral lessons, and seminars.

However, learning has broadened out to goal-based or content intent on measuring an outcome, like learning or transactional content. Through goal-based learning, an individual learns a set of pre-conceived skills during the process of completing a specific goal. Goal-based learning requires the individual to learn from the experience and mistakes, mimicking the natural learning method instead of the artificial traditional learning methods and mediums.

Current authoring tools that are used to create and deploy interactive conversational content with virtual characters, require advanced coding, 3D modeling, and other skills often not found in organizations that may benefit from this kind of content. This type of interactive conversational content with virtual characters is a time-consuming, resource-intensive endeavor requiring large teams of highly trained technical staff, especially when dealing with cross-platform delivery and/or high-quality emotional impact. Thus, many content creators focused on goal-based measurement content, such as, but not limit to, learning and development professionals, healthcare professionals, and e-commerce content creators. Many content creators cannot afford such investments.

There is a need for devices, systems and methods that provide an engaging platform experience for the learners and/or software conducive to learning and development individuals and organizations with low technological proficiency to create interactive, immersive, and/or conversational content with high-quality emotional impact.

The present disclosure is directed to devices, systems and methods that provide authoring content to create a virtual environment containing conversations between one or more users and one or more virtual characters. The tools disclosed herein may be used by individuals with no or minimal coding expertise or skills in voice-acting, animation, or 3D modeling. As disclosed herein, this is done through the use of assets packaged as data combined with the user's logic to produce a data stream of virtual content.

The present disclosure is directed to overcome and/or ameliorate at least one or more of the disadvantages of the prior art, as will become apparent from the discussion herein. The present disclosure also provides other advantages and/or improvements as discussed herein.

### SUMMARY

Exemplary embodiments of the present disclosure are directed to devices, methods and/or systems that permit a content author or authors to create content (for example, training content) through a series of blocks in a node-based system, capable of switching between user written narrative blocks and blocks written by cognitive architectures without a user in the loop or with minimum involved of the user. The node-based system may include one or more of the following: narrative blocks, decisions blocks, logic blocks and other suitable blocks. In exemplary embodiments, the author constructs the structure of these branched narratives and may choose to author branches or allow a cognitive architecture to generate the dialog and return the response to the system. The platform may present data as visual assets to the author to enable no coding or with minimum coding.

These visually branched narratives may offer an option for advanced story logic.

Exemplary embodiments are directed to platforms that allow content authors to generate interactive scripts that 3D virtual characters communicate to end-users. This may be done by one or more of the following: set-up characters; environments; linking dialog to animation and/or sound; capture facial performance to produce 3D virtual character animations; capture voice performance to produce 3D virtual characters speaking, and modify character gestures, emotions, and body language.

Exemplary embodiments are direct to a system comprising:
one or more processors;
one or more memories coupled to the one or more processors;
a display comprising a display area and coupled to the one or more processors;
a non-transitory machine-readable medium storing a virtual character authoring system comprising:
a performance editing application that is configured to allow an author to create a visual performance for one or more 3D virtual characters in a story line;
an interactive branched flow editing application that is configured to allow an author to create a story line with interactive script and one or more 3D virtual characters;
a virtual-human animation engine application that is configured to allow animation of the one or more 3D virtual characters; and
a branched flow player application that is configured to allow interpretation and running of content the visual performance;
wherein the virtual character authoring system is configured to allow the author with minimal coding expertise, skills in voice-acting, animation design, 3D modeling or combinations thereof to create a story line that is capable of being played in an interactive setting between the one or more 3D virtual characters and one or more human end users.

Exemplary embodiments are to A non-transitory machine-readable medium storing a performance editing application that allows an author to create a visual performance for one or more 3D virtual characters in a story line, the performance editing application comprising:
a first tool that is configured to allow the author to select one or more 3D virtual characters from a predefined set of virtual characters, and one or more virtual environments from a predefined set of virtual environments and add to a display area;
the display area for displaying at least in part the visual performance of one or more 3D virtual characters in the story line; and
in the display area:
   defining a dialog lane that is configured to allow the author to place one or more conversational dialog clips along a timeline of the story line, wherein the one or more conversational clips of the one or more 3D virtual characters are selected by the author from one or more dialog nodes,
   defining one or more performance lanes that are configured to allow the author to place one more performance clips, wherein the author selects the one or more performance clips from one or more sets of predefined performance clips; and
an animating tool that is configured to animate the one or more 3D virtual characters and the one or more virtual environments at least in part by data authored in the timeline of the story line by associating the one or more 3D virtual characters and the one or more virtual environments with data from the dialog lane and from the one or more performance lanes;
wherein the performance editing application is configured to allow the author with minimal coding expertise, minimal skills in voice-acting, minimal animation design, minimal 3D modeling or combinations thereof to create the visual components of the one or more 3D virtual characters that are capable of being used in an interactive narrative.

A first tool can be for example a performance editor, a flow editor, or a project setup. An animating tool can be for example a performance editor.

Exemplary embodiments are to a non-transitory machine-readable medium storing a performance editing application that allows an author to create a visual performance for one or more 3D virtual characters in a story line, the performance editing application comprising:
a first tool that is configured to allow the author to select one or more 3D virtual characters from a predefined set of virtual characters, and one or more virtual environments from a predefined set of virtual environments and add to a display area;
the display area for displaying at least in part the visual performance of one or more 3D virtual characters in the story line; and
in the display area:
   defining a dialog lane that is configured to allow the author to place one or more conversational dialog clips along a timeline of the story line, wherein the one or more conversational clips of the one or more 3D virtual characters are selected by the author from one or more dialog nodes;
   defining an emotion lane that is configured to allow the author to place one or more emotion clips along a timeline of the story line, wherein the author selects the one or more emotional clips from a set of predefined emotional clips;
   defining a gesture lane that is configured to allow the author to place one or more gesture clips along a timeline of the story line, wherein the author selects the one or more gesture clips from a set of predefined gesture clips;
   defining a look at lane that is configured to allow the author to place one or more look at clips along a timeline of the story line, wherein the author selects the one or more look at clips from a set of predefined gesture clips;
   defining an energy lane that is configured to allow the author to place one or more energy clips along a timeline of the story line, wherein the author selects the one or more energy clips from a set of predefined energy clips; and
an animating tool that is configured to animate the one or more 3D virtual characters and the one or more virtual environments a least in part by data authored in the timeline of the story line by associating the one or more 3D virtual characters and the one or more virtual environments with data from one or more of the following: the dialog lane, the emotion lane, the gesture lane, the look at lane and the energy lane;
wherein the performance editing application is configured to allow the author with minimal coding expertise, minimal skills in voice-acting, minimal animation design, minimal 3D modeling or combinations thereof to create the visual components of the one or more 3D virtual characters that are capable of being used in an interactive narrative.

Exemplary embodiments are to a system comprising:
one or more processors;
one or more memories coupled to the one or more processors;
a display comprising a display area and coupled to the one or processors;
a non-transitory machine-readable performance editing application stored in the one or more memories, the performance editing application is configured to allow an author to create a visual performance for one or more 3D virtual characters in a story line, the performance editing application comprising:
a first tool that is configured to allow the author to select one or more 3D virtual characters from a predefined set of virtual characters, and one or more virtual environments from a predefined set of virtual environments and add to a display area;
the display area for displaying at least in part the visual performance of one or more 3D virtual characters in the story line; and
in the display area:
   defining a dialog lane that is configured to allow the author to place one or more conversational dialog clips along a timeline of the story line, wherein the one or more conversational clips of the one or more 3D virtual characters are selected by the author from one or more dialog nodes;
   defining an emotion lane that is configured to allow the author to place one or more emotion clips along a timeline of the story line, wherein the author selects the one or more emotional clips from a set of predefined emotional clips;
   defining a gesture lane that is configured to allow the author to place one or more gesture clips along a timeline of the story line, wherein the author selects the one or more gesture clips from a set of predefined gesture clips;
   defining a look at lane that is configured to allow the author to place one or more look at clips along a timeline of the story line, wherein the author selects the one or more look at clips from a set of predefined gesture clips;
   defining an energy lane that is configured to allow the author to place one or more energy clips along a timeline of the story line, wherein the author selects the one or more energy clips from a set of predefined energy clips; and
an animating tool that is configured to animate the one or more 3D virtual characters and the one or more virtual environments a least in part by data authored in the timeline of the story line by associating the one or more 3D virtual characters and the one or more virtual environments with data from one or more of the following: the dialog lane, the emotion lane, the gesture lane, the look at lane and the energy lane;
wherein the performance editing application is configured to allow the author with minimal coding expertise, minimal skills in voice-acting, minimal animation design, minimal 3D modeling or combinations thereof to create the visual components of the one or more 3D virtual characters that are capable of being used in an interactive narrative.

Exemplary embodiments are to a method of using a non-transitory machine-readable medium storing a performance editing application to allow and author to create a visual performance for one or more 3D virtual characters in a story line, comprising the steps of:
using a first tool that allows the author to select one or more 3D virtual characters from a predefined set of virtual characters, and one or more virtual environments from a predefined set of virtual environments;
adding the select one or more 3D virtual characters and the one or more virtual environments to a display area and displaying the select one or more 3D virtual characters and the one or more virtual environments in the display area;
defining a dialog lane in the display area and allowing the author to place one or more conversational dialog clips along a timeline of the story line, wherein the one or more conversational clips of the one or more 3D virtual characters are selected by the author from one or more dialog nodes;
defining an emotion lane in the display area and allowing the author to place one or more emotion clips along a timeline of the story line, wherein the author selects the one or more emotional clips from a set of predefined emotional clips;
defining a gesture lane in the display area and allowing the author to place one or more gesture clips along a timeline of the story line, wherein the author selects the one or more gesture clips from a set of predefined gesture clips;
defining a look at lane in the display area allowing the author to place one or more look at clips along a timeline of the story line, wherein the author selects the one or more look at clips from a set of predefined gesture clips;
defining an energy lane in the display area and allowing the author to place one or more energy clips along a timeline of the story line, wherein the author selects the one or more energy clips from a set of predefined energy clips; and
using an animating tool to animate the one or more 3D virtual characters and the one or more virtual environments a least in part by data authored in the timeline of the story line by associating the one or more 3D virtual characters and the one or more virtual environments with data from one or more of the following: the dialog lane, the emotion lane, the gesture lane, the look at lane and the energy lane;
wherein the performance editing application is configured to allow the author with minimal coding expertise, minimal skills in voice-acting, minimal animation design, minimal 3D modeling or combinations thereof to create the visual components of the one or more 3D virtual characters that are capable of being used in an interactive narrative.

Exemplary embodiments are to a non-transitory machine-readable medium storing an interactive branched flow editing application that allows an author to create a story line with interactive script and one or more 3D virtual characters, the branch flow editing application comprising:
a display area for displaying at least one or more of the following: the one or more 3D virtual characters, one or more virtual environments, and an interactive dialog for the one or more 3D virtual characters;
a start tool that is configured to allow the author to create a start node, wherein the start node is configured to start the story line;
a dialog tool that is configured to allow the author to enter conversational dialog into at least one dialog node, wherein the conversational dialog is used to trigger audio by the 3D virtual character; an exit tool that is configured to allow the author to enter an exit to the story line in an exit node; and a connecting tool that is configured to allow the author to connect one or more nodes by connector lines to create a story line logic within the story line;
wherein the branch flow editing application is configured to allow the author with minimal coding expertise, minimal skills in voice-acting, minimal animation design, minimal 3D modeling or combinations thereof to create an interactive branch flow narrative.

Exemplary embodiments are to a system comprising:
one or more processors;
one or more memories coupled to the one or more processors;
a display comprising a display area and coupled to the one or processors;
a non-transitory machine-readable medium storing an interactive branched flow editing application that allows an author to create a story line with interactive script and one or more 3D virtual characters, the branch flow editing application comprising:
the display area is configured to display at least one or more of the following: the one or more 3D virtual characters, one or more virtual environments, and an interactive dialog for the one or more 3D virtual characters;
a start tool that is configured to allow the author to create a start node, wherein the start node is configured to start the story line;
a dialog tool that is configured to allow the author to enter conversational dialog into at least one dialog node, wherein the conversational dialog is used to trigger audio by the 3D virtual character;
a decision point tool that is configured to allow the author to create decision points in the interactive branch flow of the story line;
a conditional statement tool that is configured to allow the author to enter conditional statements in a conditional node of the story line;
an exit tool that is configured to allow the author to enter an exit to the story line in an exit node;
a connecting tool that is configured to allow the author to connect one or more nodes by connector lines to create a story line logic within the story line; and
a conditional statement tool that is configured to allow the author to enter conditional statements in a conditional node of the story line;
wherein the system is configured to allow the author with minimal coding expertise, minimal skills in voice-acting, minimal animation design, minimal 3D modeling or combinations thereof to create an interactive branch flow narrative.

Exemplary embodiments are to a method of using a non-transitory machine-readable medium storing an interactive branched flow editing application that allows an author to create a story line with interactive script and one or more 3D virtual characters, the branch flow editing application comprising the steps of:
using a display area to display at least one or more of the following: the one or more 3D virtual characters, one or more virtual environments, and an interactive dialog for the one or more 3D virtual characters;
using a start tool that allows the author to create a start node, wherein the start node is configured to start the story line;
using a dialog tool that allows the author to enter conversational dialog into at least one dialog node, wherein the conversational dialog is used to trigger audio by the 3D virtual character;
using a decision point tool that allows the author to create decision points in the interactive branch flow of the story line;
using a conditional statement tool that allows the author to enter conditional statements in a conditional node of the story line;
using an exit tool that allows the author to enter an exit to the story line in an exit node;
using a connecting tool that allows the author to connect one or more nodes by connector lines to create a story line logic within the story line; and
using a conditional statement tool that allows the author to enter conditional statements in a conditional node of the story line;
wherein the method is configured to allow the author with minimal coding expertise, minimal skills in voice-acting, minimal animation design, minimal 3D modeling or combinations thereof to create an interactive branch flow narrative.

Exemplary embodiments are to a system for automatically adjusting a virtual character's reactions based at least in part on the virtual character's interaction with a human character in a narrative interactive story line, comprising:
a display device;
one or more processors;
memory, the memory includes a one or more nodes that are configured to store input elements selected from one or more of the following: one or more virtual characters, one or more virtual environments, one or more facial expressions, one or more character poses, one or more voice activated dialog, and one or more character behaviors;
the story line stored in memory comprises input elements selected by the author from the one or more nodes that are mapped to one or more time periods in the story line and associated with each other
to the one plurality of facial expressions, the plurality of poses, and the plurality of behaviors associated with the virtual character at the one or more time periods in the story line, the input elements initially selectable by an author to select a facial expression, a pose, and a behavior for the virtual character;
the one or more processors are configured to be operable, via machine-readable instructions stored in the memory, to:
display the story line on the display device and the virtual character is configured to interact with a human as the story line progress in real time, wherein the story line displays one or more poses, one or more voice activated text, one or more facial expressions, one or more behaviors associated with the virtual character at the one or time periods in the story line;
the story line being activated by a user-selected behavior for the virtual character and provide in real time an animation of movement of the virtual character from a prior position to a position exhibiting the one or more user-selected facial expression, one or more user-selected pose, and one or more user-selected behavior, and display in real time, on the display device;
wherein the machine-readable instructions are configured to automatically adjust the virtual character's the one or more poses, the one or more voice activated text, the one or more facial expressions, the one or more behaviors based at least in part on the level of emotional interaction between the virtual character and the human.

This summary is not intended to be limiting as to the embodiments disclosed herein and other embodiments are disclosed in this specification. In addition, limitations of one embodiment may be combined with limitations of other embodiments to form additional embodiments.

### BRIEF DESCRIPTION OF THE DRAWINGS

FIG. 1 is a flow chart illustrating a configuration of a virtual character authoring system, according to exemplary embodiments.

FIG. 2 is an example of a narrative branching by interconnected nodes, according to exemplary embodiments. These nodes may be data-structures, assembling them as a stylized sequence to generate an advanced story playback logic and/or content.

FIG. 3 illustrates a user interface of a narrative branching flow framework and data-model to construct branched flows, according to exemplary embodiments.

FIG. 4 illustrates an example of how the branched flow player (also referred to as BFP) interprets and plays a branching flow framework using a state machine behavior model, consisting of a finite number of states (finite-state machine, FSM), according to exemplary embodiments.

FIG. 5 illustrates the purpose of using 3D playback to play the branched narrative flow, supporting reviewing of the authored flow in a 3D construct, according to exemplary embodiments.

FIG. 6 illustrates an exemplary subset of the data structures for the node sequence illustrated in FIG. 2 and FIG. 3. A dialog node-type which outputs spoken conversation by virtual characters.

FIG. 7 illustrates an exemplary subset of the data structures for the node sequence illustrated in FIG. 2 and FIG. 3. A ‘score’ node-type which outputs a score referenced to a subset of skills and the input of scoring criteria.

FIG. 8 illustrates an exemplary subset of the data structures for the node sequence illustrated in FIG. 2 and FIG. 3. A ‘message’ node-type which outputs messaging directed towards the end-user.

FIG. 9 illustrates an exemplary subset of the data structures for the node sequence illustrated in FIG. 2 and FIG. 3. A ‘decision’ node-type which outputs a set of options for the end-user branching the narrative flow.

FIG. 10 illustrates a subset of the data structures for the node sequence illustrated in FIG. 2 and FIG. 3. A ‘Exit’ node-type which exits the flow to a designated target.

FIG. 11 illustrates a user interface of preview configuration of the flow editor as a two-dimensional representation of the authored flow on the canvas, according to exemplary embodiments.

FIG. 12 illustrates how a node may have its own timeline, and how transition triggers (e.g., emotions or energy and/or poses), persist across nodes, according to exemplary embodiments. Unlike gestures, which typically are temporary animations that work within the scope of a single timeline.

FIG. 13 illustrates a display that may be used for setting up a virtual environment, according to exemplary embodiments.

FIG. 14 illustrates a flow for dialog nodes contain an animation timeline the user populates with smart-clip instance references, flow meta-data linked to individual smart clips hosted on the smart clip repository and user-generated-content server, according to exemplary embodiments.

FIG. 15 illustrates emotional state transitions from a current VC emotional state to a destination VC emotional state left wheel (A) is current state and right wheel (B) is target state, according to exemplary embodiments.

FIG. 16 is a flow chart illustrating smart clips interacting with additional smart clips using one or more listeners and a single output, according to exemplary embodiments.

FIG. 17 illustrate an exemplary display of a performance editor.

FIG. 18 illustrates users importing audio files from external data-sources into a project or record audio using the recording editor in the performance editor to replace synthesized speech, according to exemplary embodiments.

FIG. 19 illustrates a recording editor, according to exemplary embodiments.

FIG. 20 illustrates how projects may be stored, according to exemplary embodiments.

FIG. 21 illustrates a display that may be used to select a project group or flow, according to exemplary embodiments.

FIG. 22 illustrates a display with respect to access-locked flows, according to exemplary embodiments.

FIG. 23 illustrates a timeline transition from one emotional state to another emotional state of a 3D virtual character over a period of time, according to certain exemplary embodiments.

FIG. 24 shows an exemplary mark-up text file.

FIG. 25 shows a text file of an exemplary dialog.

FIG. 26 illustrates a representation of a selected flow, according to exemplary embodiments.

### DETAILED DESCRIPTION

The following description is provided in relation to several embodiments that may share common characteristics and features. It is to be understood that one or more features of one embodiment may be combined with one or more features of other embodiments. In addition, a single feature or combination of features in certain of the embodiments may constitute additional embodiments. Specific structural and functional details disclosed herein are not to be interpreted as limiting, but merely as a representative basis for teaching one skilled in the art to variously employ the disclosed embodiments and variations of those embodiments.

The subject headings used in the detailed description are included only for the ease of reference of the reader and should not be used to limit the subject matter found throughout the disclosure or the claims. The subject headings should not be used in construing the scope of the claims or the claim limitations.

As used herein, the term “virtual character authoring system” means a collection of systems and/or methods designed to support creation and play-back of real-time, spatial 3D interactive content around conversations and interactions between users and virtual characters.

As used herein, the term “virtual character” (“VC) means a three-dimensional representation of a character, which may be experienced using one or more of the following: virtual-reality head-sets, XR glasses, holographically, phones, tablets and desktop computers. The term virtual character includes human characters and other forms of characters that may be used, for example, dogs, cats, horses, fictional characters not trying to represent an actual living character (e.g., a talking dog, a talking statute, a talking geometrical character) or any other suitable character.

As used herein, the term “virtual character animation engine” (“VCAE”) means an application that enables animation and behavior of the virtual characters. The term virtual character animation engine includes the animation of human characters and the animation of other forms of characters may be used, for example, dogs, cats, horses, fictional characters not trying to represent an actual living character (e.g., a talking dog, a talking statute, a talking geometrical character) or any other suitable character.

As used herein, the term “airframe” means a software application that may be download and play back content construction from using the virtual character authoring system, including, but not limited to, narrative data construction with virtual character authoring system.

As used herein, the term “branched flow framework” (“BFF”) means a method, application and/or data-model that may be used to construct flows between node. The flows constructed may be branched or without branches. Certain node types may host data created at least in part by the author according to a defined data-structure.

As used herein, the term “branched flow player” (“BFP”) means a method or an application for interpreting and playing flows to, typically, the end-user. The flows interpreted and played may be branched or without branches.

As used herein, the term “author” is a user or users creating virtual character performances and/or flows. The author may be a person or a team of people. However, at least part of the authors function may be carried out by other software programs. For example, artificial intelligence software applications.

As used herein, the term “end-user” means a user experiencing 3D experiences designed by an author, including character performances and/or flows using at least in part exemplary embodiments.

As used herein, the term “clip” means one or more instructions that may be used to control the animation and/or behavior of one or multiple virtual characters in real-time. Examples of types of clips are gesture clips, emotion clips, conversational dialog clips, performance clips, look at clips, and energy clips. Apart from a type, the clip can comprise other parameters defining the information disclosed therein, for example affecting the way the one or more instructions control the animation and/or behavior of the one or more multiple virtual characters in real-time.

As used herein, the term “smart clips” means self-contained blocks (or substantially self-contained) with instructions and/or visual data to direct a virtual character (for example, a human actor's) visual performance in a specific way. A clip can be a smart clip. Smart clips can for example affect one or more other clips, both in input to other clips and in output from the other clips.

As used herein, the term “node” means an individual component containing data and/or knowledge, that may be connected by connector lines with a pre-designated direction that may make up a flow with branches or without branches. Interconnected nodes (connected by connector lines) may determine how they are linked and in which order they are played back. They may have 1-to-n in-points and/or 1-to-n outpoints. An in-point may accept one or more connector lines.

As used herein, the term “art pipeline” means a sequence of processes that take digital art and inject it into the platform so that it may be used in narrative content.

As used herein, the term “virtual environment” means a 3D environment, either indoor and/or outdoor, containing object entities, one or more virtual characters and one or more end-user(s) in real-time or substantially real-time.

As used herein, the term “art source” means an application enabling artists to insert art into art pipeline disclosed in exemplary embodiments.

As used herein, the term “content delivery network” (“CDN”) means one or more processors that may be, for example, a cloud-based solution for sharing assets to applications of exemplary embodiments.

As used herein, the term “services” means server applications storing flow content, managing access to the content and/or reporting on the progress of end-users. In exemplary embodiments, the services may be cloud-based, or other suitable platforms or combinations thereof.

Exemplary embodiments of the present disclosure provide a virtual character authoring system that outputs spatial 3D interactive content running parallel to user constructed flow with branching or without branching. This output may be preserved and/or manipulated by both the end-user and/or the virtual character. Rather than performing fully separate processing for each operation, the virtual character authoring system performs certain 3D asset preparation operations whenever possible, then plays the content in real-time.

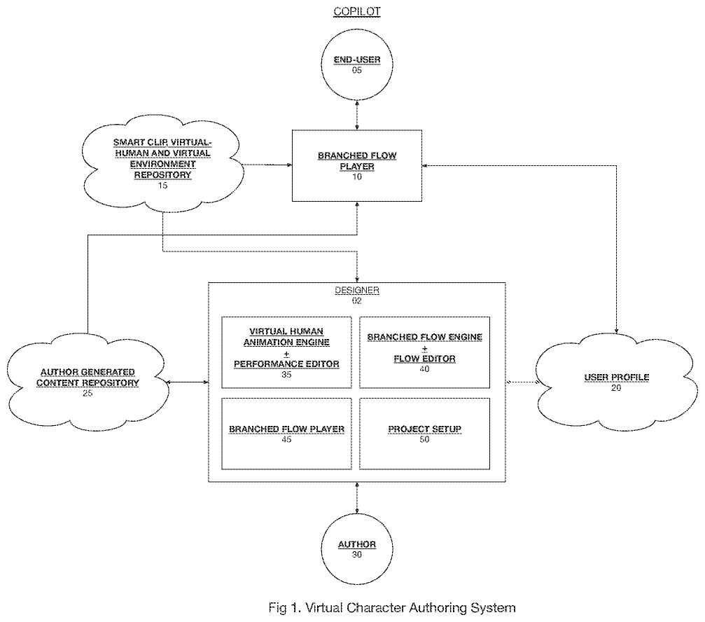

FIG. 1 illustrates a flow chart of exemplary embodiments. This exemplary configuration supports the creation and/or play-back of real-time, spatial 3D interactive content around conversations and interactions between users and virtual characters, according to the virtual character authoring system. Specifically, component, is a system and/or method used by authors 30 including content creators, designers and writers, to create and deploy spatial, real-time, interactive, virtual 3D experiences around interactions between end-users (for example, humans) and virtual character.

As shown, the virtual character authoring system includes multiple methods and systems: The branched flow framework with the flow editor user interface 40 virtual character animation engine 35 with the performance editor user interface, a content repository of virtual characters, virtual environments and smart clips 15 and methods to create and configure projects 50 including project deployment of the authored project content which the output may be directed for end-users consumption 5. An end-user's user profile 20 may authenticate on a cloud server and may be assigned user permissions by the server administrator.

The branched flow player 10 and 45 may be configured to interpret and run content created with the virtual character authoring system. The branch flow player may be integrated into the virtual character authoring system for real-time playback of authored content 25, and in addition runs independently 45 as its own system on several hardware platforms, including but not limited to virtual-reality, augmented-reality, mobile, desktop devices or combinations thereof.

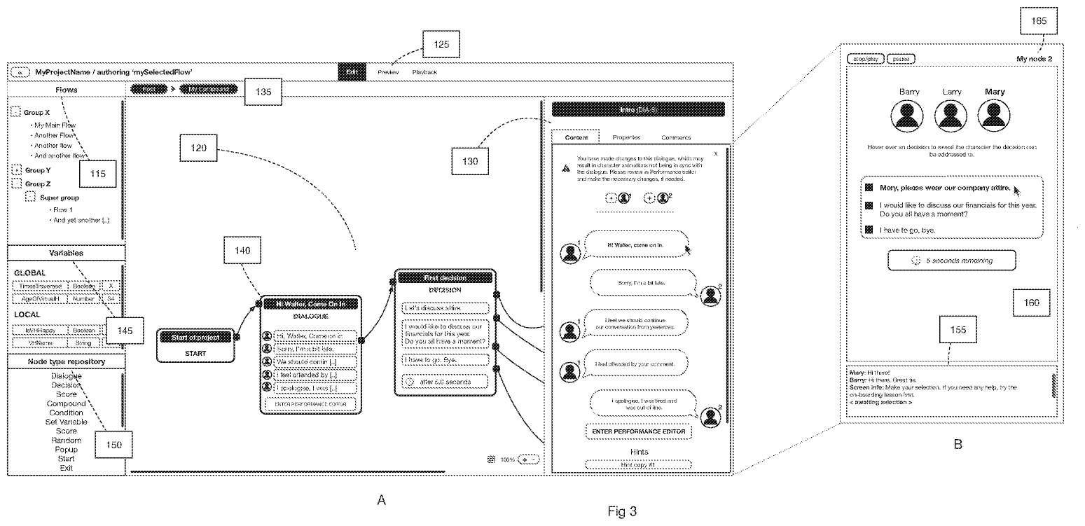

The branched flow framework (BFF) is a data-model that represents a flow. Nodes of a specific node type may host data created by the author, according to a fixed data-structure standard. Author construct flows out of node instances and connector-lines, and author its data using the flow editor interface FIG. 3.

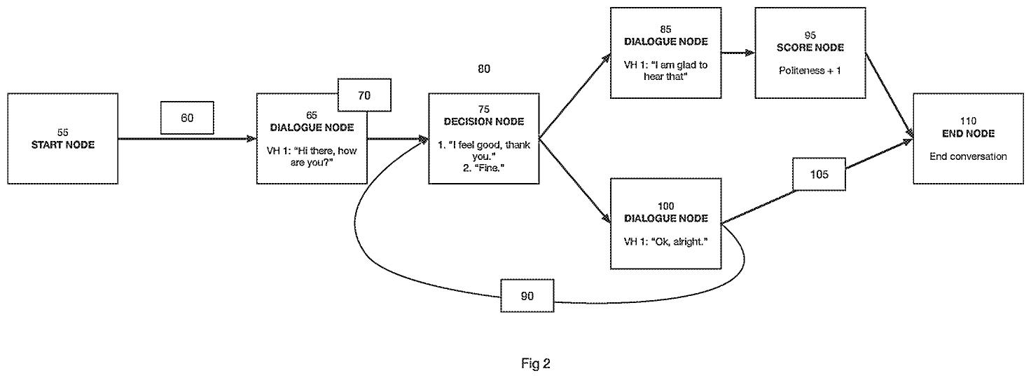

An individual component of a certain type containing data and/or knowledge, that may be connected by connector lines with a pre-designated direction that may make up a branched flow, otherwise known as nodes shown in FIG. 2. Start node 55 is connected to dialog node 65 by connector line 60. Dialog node 65 is connected by connector lines 60 from out-points 80 to in-points 85, optionally looping-back 80. Multiple connected nodes may be referred to as a flow which may be played back by the author or end-user using a method for interpreting and playing branched flows to the end-user. It may be embedded in the virtual character authoring system and a receiving application that may be downloaded and play back content created, including, but not limited to, narrative data, the receiving application otherwise known as branched flow player (BFP.)

The flow editor is a method to visually construct flows. The flows constructed may be branched or without branches. It is the user interface to the BFF and BFP configurations.

FIG. 3 illustrates a repository of node types 150 which may be propagated onto canvas 120 to create a new instance of the selected type. In this example, each node contains a unique identifier that the receiver reads and may be optionally labeled by the author. An example node-type in FIG. 3 is dialog 140 which hosts conversational copy spoken by virtual characters. When selecting a node of a certain type, a properties pane 130 is displayed with tools and data-structure hosting data related to its type (in this example, the dialog node). The author may add, remove and/or edit the and its records on the properties pane.

The author adds, removes and/or edits flows containing nodes in 115; a single project may contain 1-to-n flows and groups. Flows may be daisy-chained by connecting an exit node of flow x, to the start node of flow y. The author creates variables 145 to use in conjunction with logic node-types to create advanced branching logic and/or conditions. Global variables may be shared across one or more flows in a project and may be stored persistently for the active end-user. Local variables may be stored in memory and may be accessible for the duration of the experience and may be constrained to a single flow. Variables may have the following types: boolean (true/false), number (integer), float, and string. The author may preview an authored flow (125 a visual simplified representation) or playback the flow in 3D 125, a full 3D spatial experience using the integrated BFP) to test and validate if the authored flow leads to the desired result.

In FIG. 3 165 is a compound node as a child-flow of the parent flow, holding 0 to n nodes. The author enters and exits a compound node in flow editor. 135 is showing that the breadcrumb navigation element conveys the author's position in the hierarchy, where the leftmost element represents the root, and subsequent breadcrumb navigation elements represent a child of its preceding parent element. Compound nodes may reduce visual clutter and/or perceived complexity of the canvas and allow for creating functions by (re)using compounds on a parent level. In this example, the compound node contains no applicable visual BFP representation to the end-user. When the branched flow player encounters a compound node, it may enter the compound node and traverse the flow inside the compound, and move back to its parent flow when an exit node is encountered.

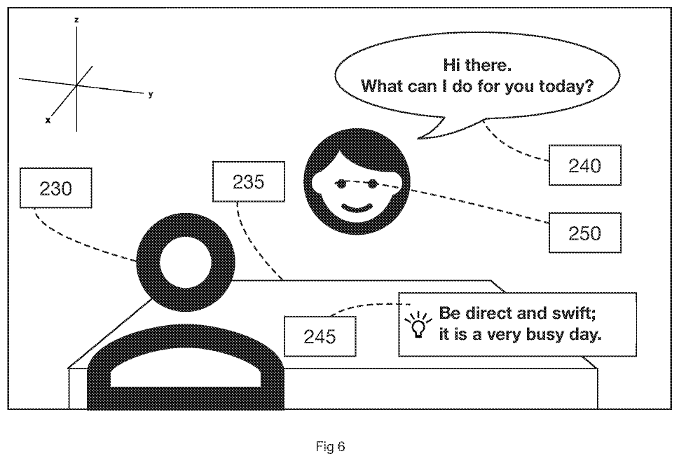

FIG. 6 shows a dialog node that hosts conversational data and/or related meta-data output to the receiver and read by the virtual character in text to speech recognition to converse. A dialog node may provide access to the performance editor, which may act as the interface to design character performances using virtual character animation engine (VCAE). When the BFPlayer encounters a dialog node, virtual characters 250 may trigger a speech synthesis version of the copy the author has created with optional human voice-actor recordings, readable subtitles 240 and hints 245. virtual characters may automatically orient the head, eyes, upper body and lower body and speech towards the end-user 230 or other active virtual characters, which may be manually overridden with custom triggers by the virtual character authoring system's author.

Each node in an experience represents a type of interaction or content. For example a decision, a reward, a dialogue, et cetera. A user can tie instances of nodes of a specific type together with connector lines, and these create sequential or parallel actions forming the end-user experience that the user can see, hear and interact with. Each single node can have a timeline. For example, a dialogue node can be equipped with a timeline. This timeline can contain Smart Clips that e.g. control the virtual character's emotions, poses and/or gestures.

A dialogue node with a timeline embedded therein has a ‘start’ and an ‘end’ of the timeline. When the experience reaches the dialogue node in question, the beginning of the timeline can initiate. When the end of the timeline is reached, the current node ends and the next node in the flow is triggered. A timeline can have one or more lanes. Each lane can be assigned to one of the present Virtual Character. Content, for example Smart Clips, on that lane will only affect the virtual character it is assigned to. Basically a timeline and its data is a ‘child’ of the ‘parent’ node which in return is part of a larger flow.

Table one below provides some of the node types that may be used with exemplary embodiments.

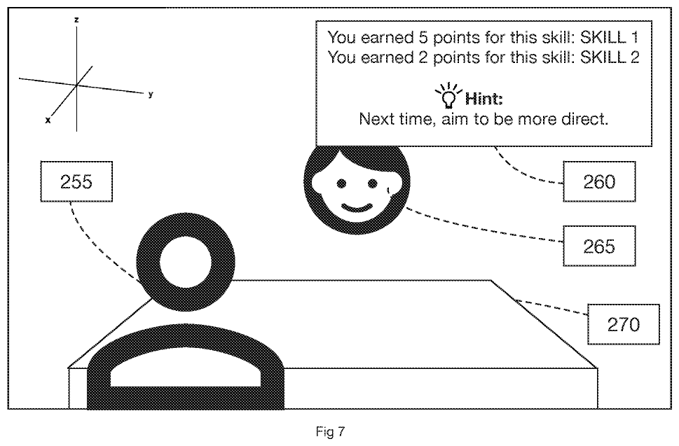

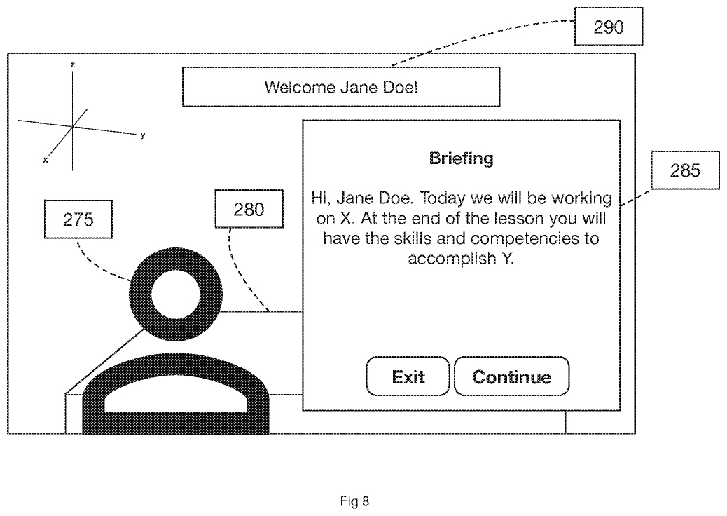

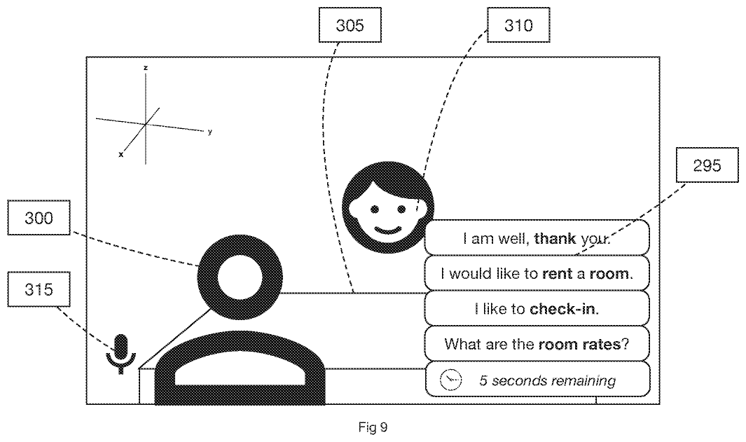

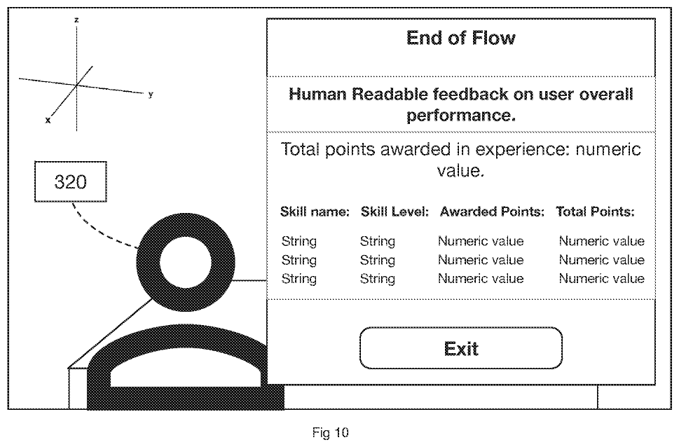

TABLE 1

| | Representation in Flow Editor | BFP Representation (End-User |
|---|---|---|
| Node Type | (authoring) | Experience) |
| Compound | A node representing a child-flow of | This node type has no visual |
| | the parent flow, holding 0 to n | representation. |
| | nodes. The author enters and exits a | When the branched flow player |
| | compound node in flow editor. The | encounters a compound node, it may |
| | breadcrumb navigation element | enter the compound node and traverse |
| | (FIG. 3, 135) conveys the author's | the flow inside the compound, and move |
| | position in the hierarchy, where the | back to its parent flow when an exit |
| | leftmost element represents the | node is encountered. |
| | root, and subsequent breadcrumb | |
| | navigation elements represent a | |
| | child of its preceding parent | |
| | element. | |
| | Compound may reduce the node's | |
| | visual clutter and/or perceived | |
| | complexity of the canvas and allow | |
| | for creating functions by (re)using | |
| | compounds on a parent level. | |
| Dialog | This node hosts conversational data | FIG. 6 - BFP (with 3D Playback |
| | and related meta-data used for | configuration): |
| | virtual characters to converse. | When the branched flow player |
| | A dialog node may have a self- | encounters a dialog node, virtual |
| | contained timeline and provides | characters 250 may trigger a speech |
| | access to the performance editor, | synthesis version of the copy the author |
| | which is an interface to design | has created with optional character |
| | character performances using | voice-actor recordings, readable |
| | VCAE. | subtitles 240 and hints 245. Virtual |
| | | characters may automatically orient the |
| | | head, eyes, upper body and lower body |
| | | and/or speech towards the end-user 230 |
| | | or other active virtual characters, which |
| | | may be manually overridden with |
| | | custom triggers by the designer author. |
| Decision | Decision nodes allow the author to | FIG. 9 - BFP (with 3D Playback |
| | create specific decision points in | configuration): |
| | the branched flow. | When the branched flow player |
| | The decision point may create an | encounters a decision node, the |
| | associated out-point on the node, | experience halts indefinitely until the |
| | establishing a branch structure. | end-user has selected one of the decision |
| | Decision points may be exposed | options 295 by selecting it with the |
| | dynamically based on conditions | applicable controller such as mouse, |
| | provided by the author. The | keyboard, virtual-reality headset gazing |
| | decision point may be allocated to n | or controller input, voice-recognition |
| | virtual characters. A fallback | 315 or when applicable, the timed |
| | decision outpoint may be added | fallback outpoint triggers. |
| | automatically to prevent the | |
| | decision to dead-lock, when | |
| | applicable. A timed fallback | |
| | outpoint may be added by the | |
| | author in case it is desired to | |
| | enforce a timely response by the | |
| | end-user. | |
| Set Var | This node type sets the value of one | This node type has no applicable visual |
| | or more variables in the project FIG. | representation. |
| | 3, 145. | |
| Condition | This node type may be used to | This node type has no applicable visual |
| | create conditional statements. The | representation. |
| | author constructs conditions by | When the branched flow player |
| | adding AND or OR statements | encounters a condition node, the |
| | using variables and evaluation | conditions may be evaluated, and based |
| | criteria. Each condition may | on the outcome BFP branches to one of |
| | generate a node outpoint. | the applicable outpoints. |
| Random | This node type may branch a flow | This node type has no applicable visual |
| | based on weighted randomization | representation. |
| | configured by the author. Each | When the branched flow player |
| | weight may correspond to an | encounters a random node, it may |
| | outpoint. | initiate randomization based on the |
| | | weighted randomization criteria set by |
| | | the author, and branch to one of the |
| | | applicable out-points. |
| Start | This is the first node in a flow. BFP | When the branched flow player |
| | seeks this node to determine the | encounters a start node, it may initiate |
| | starting point. | playback and/or display standard |
| | Compound nodes allow for multiple | messaging and/or visual effects to |
| | start nodes, corresponding to the | communicate to the end-user the |
| | amount of in-points on the parent | experience has commenced. |
| | level. A start-node, during | |
| | playback, may initiate the | |
| | conversation and/or triggers user | |
| | onboarding functionality. | |
| Exit | Exits the flow to a designated | FIG. 10 - BFP (with 3D Playback |
| | target. A target may be set to a flow | configuration): |
| | selection screen or other parts in the | When the branched flow player |
| | application. The author may define | encounters an exit node, it may |
| | whether the exit should trigger an | optionally display a screen summarizing |
| | end-result screen communicating | the end-user's performance, after which |
| | the user performance, such as | it moves to the author designated target. |
| | scoring and/or optional | |
| | personalized user feedback. | |
| Nerd | Designed for developers to inject | This node type has no applicable visual |
| | custom data structures and/or | representation. |
| | instruction into BFP for testing new | |
| | and/or existing functionality. | |
| Message | Triggers type of messaging, such as | FIG. 8 - BFP (with 3D Playback |
| | user-briefings and/or notifications | configuration): |
| | to the end-user, when played back | Triggers types of messaging, such as |
| | using BFP. | user-briefings and/or notifications to the |
| | | end-user, when played back using BFP. |
| Score | Displays a list of standardized skills | FIG. 7 - BFP (with 3D Playback |
| | hosted on a server. The author | configuration): |
| | selects the applicable skill and skill | When the branched flow player |
| | level (for example, basic, | encounters a score node, it may award n |
| | intermediate or expert) and an | score points for n skills and browse a list |
| | associated numeric value, | of skills v. |
| | representing points awarded to the | The score values may be stored on the |
| | end-user. | server associated with the current active |
| | | end-user. |

### Branched Flow Player (BFP)

The branched flow player may be used to interpret and/or play a BFF flow using a state machine behavior model, consisting of a finite number of states (finite-state machine, FSM). Based at least in part on the current state and a given input, the machine performs state transitions and produces outputs. The player may be used with flows that are branched and with flows that are not branched.

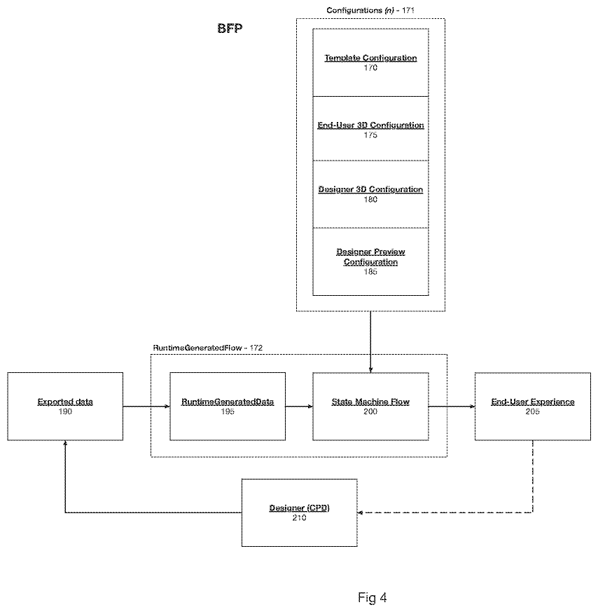

As illustrated in FIG. 4, interpreted and/or exported data 190 from designer 210 may be converted to a runtime generated flow 172. The desired configuration 171 may be fed to the state machine flow 200 responsible for how to present the runtime generated data 195 to the end-user, resulting in the end-user experience 205. For specific configurations, the end-user experience may be experienced in designer 210. In FIG. 4, the 195 the runtime generated data may be a data collection that contains information comprising a full branched flow. It may be arranged to be compatible with the state machine flow. The runtime generated data may be constructed from an exported data file. In FIG. 4 200, the state machine flow provides easy creation and execution of app flows. This framework may be used to play and/or preview a branched flow. By dynamically creating a state machine flow using the runtime generated data 195 as input, a runtime generated flow 172 may be constructed. The state machine flow 200 does not have to be manually crafted by engineers, but automatically generated from an exported Data file 190.

### Configurations

The constructed runtime generated flow may contain information about the branched flow. For example, which nodes the branched flow consists of, what data the nodes contain, and/or how the nodes are linked. Using configurations and the BFP engine and its algorithms, this data is visualized to the end-user, where the configuration affects how interactions, visual rendering, and audio is presented.

### Template Configuration

As shown in FIG. 4, a base configuration 170 containing logic shared between configurations. This configuration may act as a foundational template for other configurations. It contains setting, getting, and comparison of branched flow variables, shared across other configurations. This configuration does not feature a visual representation and cannot be experienced by an end-user.

### End-User 3D Configuration

In FIG. 4, the end user 3D Configuration 175 outputs a spatial, real-time 3D rendition of the branched flow data including a virtual environment or environments. Virtual characters may be animated using VCAE based on data authored in virtual character timelines using the performance editor interface, spatial user-interfaces as part of the 3D configuration, user controls optimized for the end-user hardware, and microphone input to interact with entities present in the 3D space. The configuration is provided with the purpose of end-users experiencing flows created by authors. BFP traverses through the nodes in the flow and presents the result to the end-user. The 3D configuration prioritizes a high degree of perceived realism and graphics fidelity within the hardware constraints of the end-user device. The configuration may be played back on one or more of the following: a desktop computer in a window or full-screen, as stand-alone mobile and tablet application, augmented reality or virtual reality application, or through streaming technology where BFP is hosted on the server and its output is streamed to the end-user as a video signal, with the end-user providing input sent to the server to enable two-way interaction between the end-user and BFP.

### Designer 3D Configuration

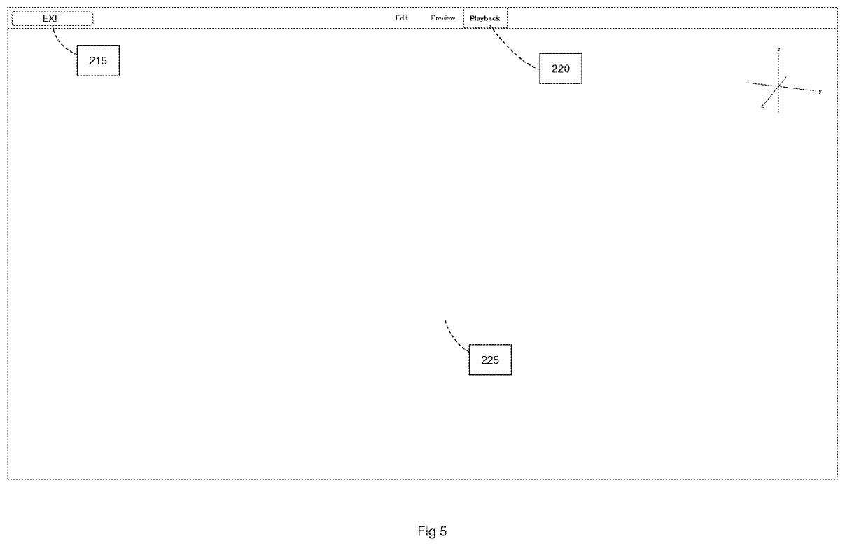

In FIG. 4, the designer 3D configuration 180 may output a spatial, real-time 3D rendition of the branched flow data including a virtual environment or environments, virtual characters may be animated using VCAE based on data authored in virtual character timelines using the performance editor interface, spatial user-interfaces as part of the 3D configuration, user controls optimized for designer desktop usage, and microphone input to interact with entities present in the 3D space. The configuration may be provided with the purpose of playing branched flows using 3D Playback in designer, supporting efficient and instant reviewing of the authored flow. BFP traverses through the nodes in the flow and presents the result to the author. The 3D configuration prioritizes a high degree of perceived realism and graphics fidelity, simulating the final end-result experienced by end-users. The configuration may be played back on a desktop computer in a window or full-screen. The configuration in designer visually takes over the majority of the screen (FIG. 5, 225) when activated by selecting playback (FIG. 5, 220). The experience may be stopped by selecting one of the other two options (edit, preview) or by selecting Exit (FIG. 5, 215). The configuration allows the author to start or stop the branched flow play-back from a selected node at a given time. Interactions may be designed for desktop computers (macOS, Windows, Linux).

### Designer Preview Configuration

In FIG. 4, the designer preview configuration 185 is used for the preview function in designer. The configuration may output a rendition of the branched flow without spatial 3D assets, prioritized to be instantly available to the end-user, runs on desktop machines with modest graphics hardware specifications, prioritizes playback speed over visual fidelity. The preview function and configuration serve efficient review of narrative structures and logic by the author.

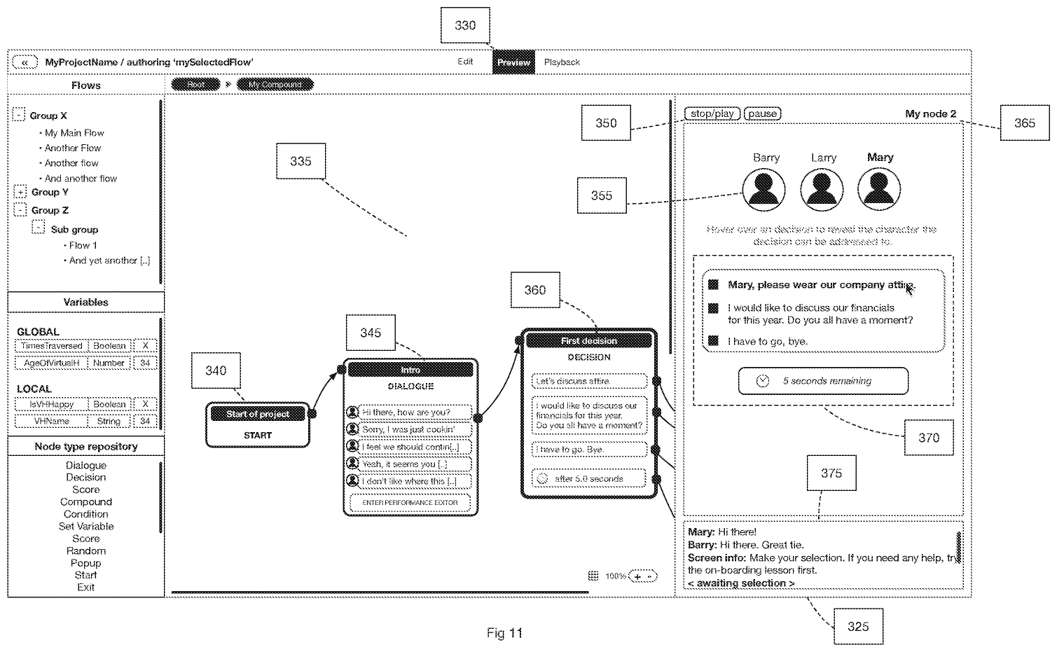

In FIG. 11, the preview function in the flow editor using the preview configuration may be rendered in flow editor when played back as a two-dimensional representation of the authored flow on the canvas 335. When an end-user activates preview 330 from the flow editor interface, the canvas 335 may be oriented towards the start node 340, highlighting the node as active (360—example of highlighted node). In case the user has selected a specific node on the canvas 335, the selected node may be used as the starting node. From either the pre-selected node or the start node, the flow may traverse to the next connected node, as demonstrated in 335 where the start node 340 may be connected to a dialog node FIG. 6, 250, and this node may be connected by a decision node FIG. 9, 310.

Depending on the current active node and its type, the preview visualization pane 325 in FIG. 11 may provide a visual representation of the node 370. The current selected node name may be displayed on the top 365. Controls to stop, pause or continue playback may be made available 350. For specific node-types involving virtual characters, image thumbnails and virtual character names setup in project setup may be displayed 355. For each node type, controls may be displayed.

### Virtual Character Animation Engine

The virtual character animation engine (VCAE) is a real-time (or substantially real-time), 3D spatial animation engine configured to be used for interactions between real humans and virtual characters, including one or more of the following: simulation of nuanced interpersonal situations, practicing soft skills in a virtual environment, pre-visualization, virtual guides, and virtual presenters. The VCAE is an example of an engine that works together with the animating tool, for example the performance editor, that is configured to animate the one or more VC and the one or more virtual environments at least in part by data authored by the author.

The virtual character animation engine is the technical backbone that can be used in the animating tool and/or in the final end-user experience. When it is used in the animating tool it can be accompanied by a user interface (such as the lanes, the clips) so that an author can create the instructions for the virtual character animation engine in a user-friendly manner (e.g. visual, drag 'n drop) and these instructions can then be applied using this animation engine to e.g. the lips, head, limbs, or other parts of the virtual characters.

When it is used in the end-user experience the same animation engine can be used to apply the authored instructions to the character, but now with a user-interface designed for the consumption of content (playback) rather than for example authoring.

VCAE may be used to control the animation and/or behavior of one or multiple virtual character in real-time (or substantially real-time) by feeding it with instructions. These instructions may be one or more of the following: temporary animation events (gestures), emotions, and energy transitions. Gesture instructions may define a particular temporary animation event that the VC can perform. Emotion instructions may define a particular emotional state of the VC, effecting the appearance and/or behavior of the VC. Energy instructions may define a particular energy state of the VC, effecting the appearance and/or behavior of the VC. Instructions to the animation engine may be spoken word (as text) influencing lip synchronization and end-user information through software algorithms and hardware sensors such as eye motion, heart-rate and/or body temperature. Based on one or more of these instructions, the system's output animates and alters the visual appearance and/or behavior of a virtual character, including, for example, facial expressions, body gestures, body poses, lip synchronization or combinations thereof in light of e.g. the particular gesture, emotion and/or energy instruction received as input. Other suitable alterations the visual appearance and behavior of a virtual character are also contemplated. The output may affect the appearance and/or behavior of a virtual character temporarily or persistently. Furthermore, the system output is able to control generative speech modifications and optionally feed its output data into the branched flow framework, allowing the state of a virtual character to influence the direction of a branched flow. Lastly, the state of a virtual character may be stored for analytics purposes. Analytics purposes include the ability for administrators to correlate VC states over time with end-user decision points and end-user progression through 1-to-n flows. VC state data may also be utilized in subsequent interactions between VC and end-users (the “memory” of a virtual character impacting the branch behavior). The VC state (e.g. emotional state, energy state) describes the state of the virtual character at a particular moment in time (e.g. respectively in terms of emotion or energy) and can be used as input or output to particular nodes within the flow of the current interaction or in a subsequent interaction.

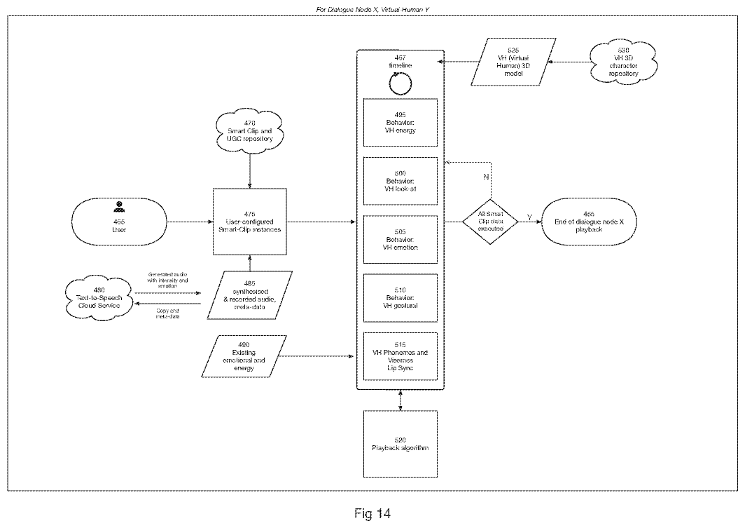

FIG. 14 illustrates a flow for dialog nodes contain an animation timeline 467 the user 465 populates with smart-clip instance references 475, flow meta-data linked to individual smart clips hosted on the smart clip repository and user-generated-content server 470, according to exemplary embodiments. The populated timeline 467 may be executed every frame, applying the animation and mesh transformation data encapsulated in individual smart-clips based on the smart-clip type using the playback algorithm 520, resulting in VC animation and VC behavior 495-515, taking in account existing VC emotional and energy states from previous dialog node timelines 490. Once the timeline finishes executing smart-clips, it reaches the timeline end-point, 455 and signals BFP to traverse to the next connected node. VC synthesized speech and/or recorded audio 475, in combination with smart-clip data 475 and the playback algorithm 520, provides the data required to synchronize VC lips, lower-face, upper-body, lower-body, placement in the 3D environment, and tongue-motion, with audio.

In contrast to VCAE, traditional 3D animation systems work by manually animating character rigs, by using techniques such as motion-capturing using human actors, or by triggering individual animation clips based on ‘actions’ (as opposed to emotions and energy).

### Smart Clips

Smart clips are self-contained blocks with one or more of the following: programmatic instructions, 3D animations, meta-data and binary assets. Smart clips may be used to direct a virtual character's performance, which, when placed on a timeline, direct a virtual character to change their emotional state, body pose, energy state, perform certain body gestures at a specific time or combinations thereof, for a specific duration, at a provided strength and/or transition curve. Smart clips hosted on a timeline may be referred to as smart clip instances. Each instance may be configured by the end-user within the constraints defined by VCAE and the individual smart clip.

Smart clips, in conjunction with the VCAE playback algorithm, include logic on how to layer, blend or ease into or out of multiple clips, resulting in smooth and believable virtual character performances. By using smart clips, different emotional states, body poses, energy states, certain body gestures can be incorporated into the virtual characters state, behavior, and/or appearance at a specific time without the need for an author with minimal coding expertise, minimal skills in voice-acting, minimal animation design, minimal 3D modeling or combinations thereof to create the visual components of the one or more 3D virtual characters that are capable of being used in an interactive manner. Since the different (smart) clips can be preprogrammed, the author can focus on the logical flow of the visual performance, placing the (smart) clips within the logical flow and using the (smart) clips to control the virtual characters state, behavior, and/or appearance at a specific time. Furthermore, the (smart) clips can act on the virtual characters state, behavior, and/or appearance in a combined manner, making it possible to combine for example different gestures with different emotional states and/or energy states. Traditionally, each of these combinations would have to be achieved by manually animating character rigs, by using techniques such as motion-capturing using human actors, or by triggering individual animation clips based on ‘actions’.

Smart Clips may also be triggered automatically by the VCAE playback algorithm. In such cases, automatic triggering of these smart clips occur based on end-user input using hardware sensors in real-time (for example, speech emotion detection, heart-rate, blood pressure, eye pupil motion and dilation, temperature, or combinations thereof), the current state of a virtual character, algorithms, the active branched scenario being played back, and the virtual character's stored memory about the human end-user gathered from previous interactions. In this way, the end-user via the end-user input can have a direct effect on the virtual characters state, behavior, and/or appearance at a specific time.

The virtual character's one or more poses, one or more voice activated text, one or more facial expressions, et cetera, can be automatically adjusted based at least in part on the level of emotional interaction between the virtual character and the human. The emotional interaction can be based on several inputs, for example it can be manually authored for the virtual character, it can be based on the active emotional state through an emotion smart clip transition (e.g. the author determined on a particular timeline that the character should be sad), it can be automatically determined from real human performance thus affecting the virtual human emotion, it can be determined based on the emotional state from previous sessions, it can be determined based on the interpretation of end-user voice-recognition (e.g. analyzing the text itself, analyzing detected emotions through shouting, anger, whispering, calmness, voice timbre, et cetera), and/or it can be interpreted based on other user behavior measured through other hardware (e.g. eye direction tracking, pose, facial expression, body warmth).

Each input can have its own weight factor, for example with 1.0 being the maximum and 0.0 the minimum (i.e. no influence). The value of all inputs combined can lead to a probability factor, and this value can determine how a virtual character responds to an end-user. This can be done in a branched fashion. For example, the flow can branch out to a first option if the probability of ‘sarcastic’>0.5, or else branch out to a second option. For example, the first option can be a frustrated ‘head scratch’ animation, while the second option can be a normal ‘head scratch’ animation.

Another factor can be ‘memory’. If the user e.g. has been sarcastic or angry for many times in the current or previous sessions, the virtual character may take the previous experience into account by detecting a sudden change in emotion (for example suddenly happy) or a continuation of the same emotion (the Virtual Character can assume the user is angry once again). The same can be done for change or continuation in other end-user input.

The invention thus allows for custom behavior, and can be made dependent on the behavior of the end-user in an automatic way. The invention is adapted to take end-user input into account, and thus enable the author to be able to design scenes which are context dependent. The performance is not only more easily authored by the use of smart clips, but also by making it more easy to implement end-user input and dynamically changing the scene on the basis of this in an automatic way.

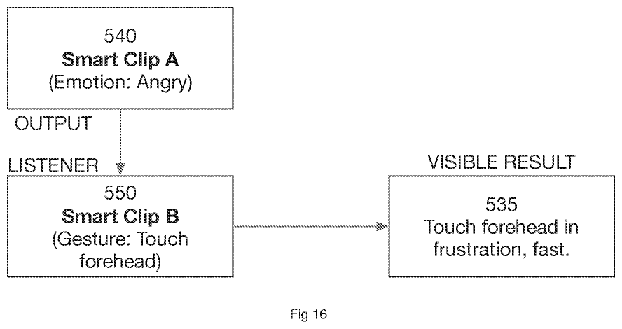

FIG. 16 illustrates an exemplary smart clip where a virtual character emotion state is set to angry, triggered by smart clip A 540. Smart clip B gesture 550 triggered at (or around) the same time and uses a listener to gather the emotional state information, which affects which animation encapsulated in smart clip B 550 is played back, and how it is played back 535, including animation clip timing, speed, blending, easing and/or layering.

### Listeners (Input)

Smart clips may interact with other smart clips using one or more number of ‘listeners’ and a single output. The smart clip container may have n listeners and one output. The output may be decided by the criteria algorithm which evaluates the input. Smart clips may contain one or more animation clips of one or more types. A Smart clip may be persistent (transform into a new state) or have a temporary effect on the virtual character for the duration of the smart clip.

### Output

The output may be selected from a list of referenced animation clips. The list of animation clips is variable in amount and is able to contain animation clips of any suitable type. A clip may have one or more parameters assigned individually, such as playback speed, timing anchors, loop/clamp, and strength.

### Criteria Algorithm

The criteria algorithm compares the listener input values to hard-coded settings and generates a value within a range (0 . . . 100). This range represents a continuum on a part of the spectrum representative of the list of animation clips.

In one exemplary form, the algorithm may take the energy level and compare this with the animation list. Additionally, it may also evaluate emotion values.

### Emotion and Energy Smart Clip Type

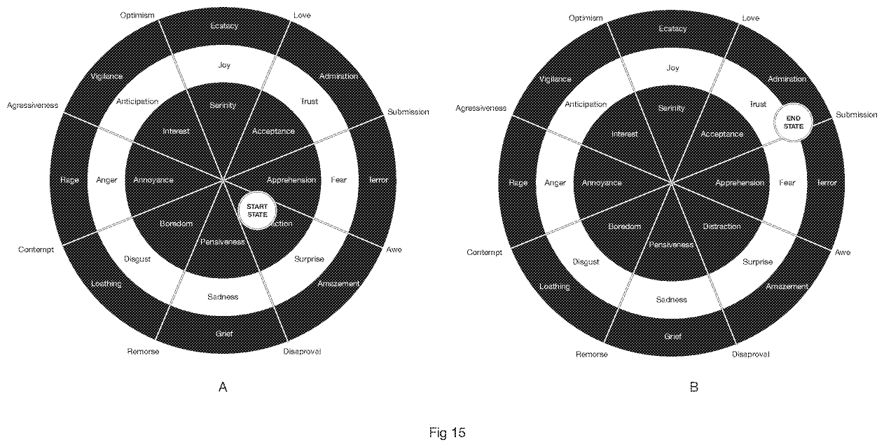

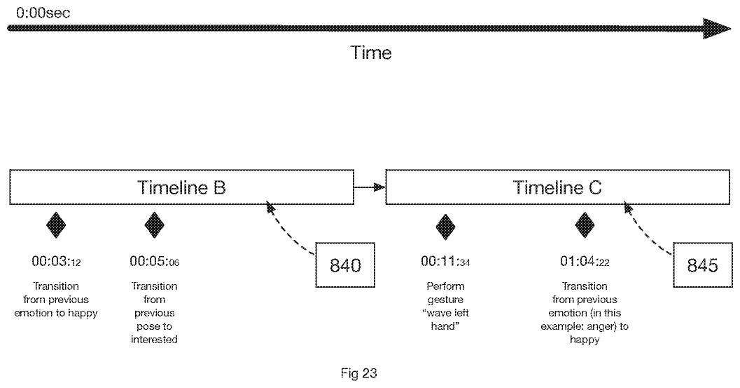

Emotion may be a persistent transition from the current VC emotional state to a destination VC emotional state (see FIG. 15: left wheel; current state, right wheel: target state). A transition happens over time with a predetermined destination emotional coordinate FIG. 15, expressiveness factor (0.0 to 1.0) and in- and out transition curves (bezier or lineair). The outermost layers of the circle represent a higher degree of expressiveness of the emotion, whereas the inner layers a lower degree. FIG. 23 illustrates and example of a transition in emotion of 3D virtual character over period of time.

Emotion can affect one or more of the following: speech synthesis output, facial expressions, gesture and pose smart clips, and virtual character idle behavior. Emotion may influence which branch in a node with multiple end-points is prioritized for playback.

Energy, similar to emotion, may be a persistent transition from the current VC energy state to a destination VC energy state. A transition happens over time with a predetermined strength (0.0 to 1.0) and in- and out transition curves (bezier or lineair). Energy can affect one or more of the following: virtual character body poses and the expressiveness of gestures performed, speech synthesis output, and virtual character idle behavior. The energy smart clip may include an optional body pose (for example, lean forward interested or informal, relaxed pose).

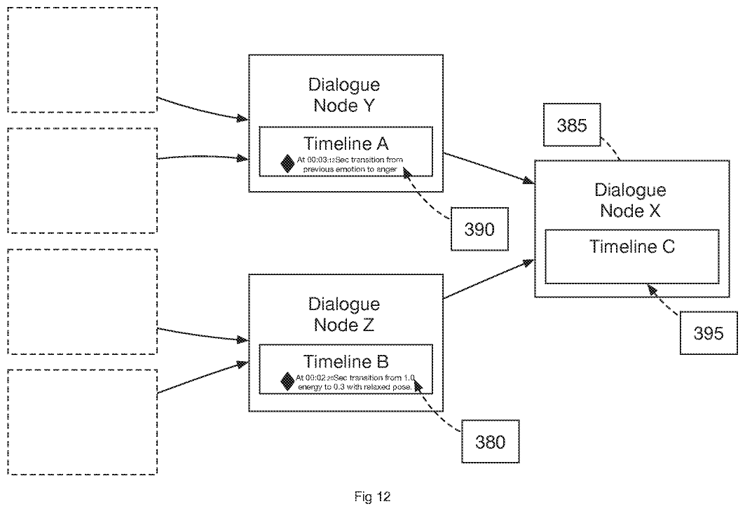

FIG. 12 illustrates how a node may have its own timeline, and how transition triggers (e.g., emotions or energy and/or poses), persist across nodes, according to exemplary embodiments. Unlike gestures, which typically are temporary animations that work within the scope of a single timeline. In FIG. 12, node X 385 is in a branched flow that may be connected by 1 to n amount of preceding nodes through connector-lines (input). In this example dialog node X 385 initiates the VC dialog with an angry VC, only when timeline C 395 is preceded by timeline A 390 as emotion and energy transitions are persistent transitions. As an example, Dialog Node Y sets the emotion to anger (390), and the character then remains angry when it reaches Dialog Node X (385) even if both nodes have a separate timeline with a beginning and end. But in case Dialog Node Z would be preceding Dialog Node X, the character would be in a relaxed, low energy state when reaching Dialog Node X.

### Gesture Smart Clip Type

Gesture smart clips may be temporary animation events with a start time and fixed duration affecting one or more parts of the body, including, for example, face, head, upper body, hand, arm, feet and/or lower body parts. The perceived expressiveness of a performed gesture by the virtual character may be determined by the smart clip strength parameter and/or easing parameters.

The appropriate animation clip encapsulated in the smart clip, including speed, blending, easing and layering, may be triggered by the playback algorithm, using emotion and energy as input parameters. 1-to-n gestures may be layered and triggered at the same time for n virtual characters.

### Look-At Smart Clip Type

Look-At smart clips are temporary events with a start time and fixed duration, affecting the focus-point and orientation of a virtual character. The perceived expressiveness of a look-at event may be determined by the smart clip strength parameter and/or easing parameters. A transition occurs over time with a predetermined X, Y, Z coordinate (such as a virtual object present in the virtual environment or another virtual character body part), expressiveness factor (0.0 to 1.0), in- and out transition curves (bezier or lineair or spline).

The look-at smart clip instance may require the user to provide a destination object present in the virtual environment or a X, Y, Z coordinate. The VCAE playback algorithm, in conjunction with the animations and instructions encapsulated in the look-at smart clip instance may orient and rotate the head, neck, upper body and eye position the eyes of a virtual character towards the point of interest over a specific time.

The VCAE playback algorithm may be configured by default to apply look-at smart clips automatically based on which VC is actively speaking. For example, when VC 1 is speaking, VC 2 and VC 3 will automatically face VC 1. When a user decision is active (decision node) and the system is waiting for user-input, one or more of the VC's in the same sub-location (group) may face the human end-user when the user is actively speaking or making a selection using the input device. The playback algorithm behavior may be overridden by smart clips hosted on the timeline for one or more of the VCs present in the virtual environment.

### Performance Editor (Main Timeline)

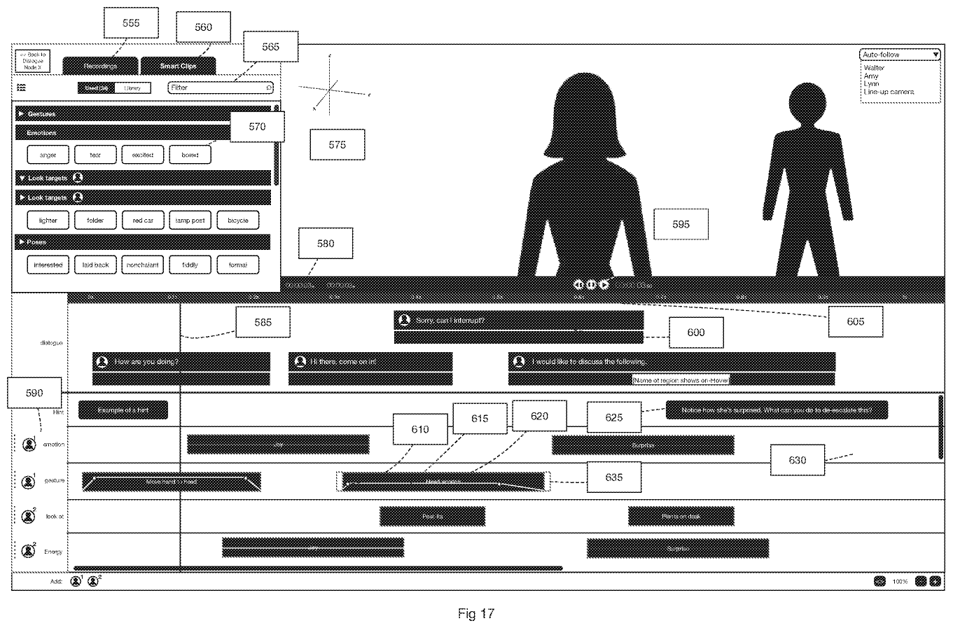

An exemplary performance editor is illustrated in FIG. 17. The performance editor is a method to visually construct VC performances. It may be an end-user interface to the virtual character animation engine. One or more dialog nodes in a flow (branched or not branched) may contain a unique instance of the VCAE timeline, visualized to the end-user with the performance editor interface. The author can have selected an environment and the desired Virtual Human's somewhere else in the application (e.g. in Project Setup). This selection can be made on a per-flow basis. So each flow in a project can have its own single environment, and one or more Virtual Characters associated. In project setup the author can also decide where these Virtual Characters are positioned (from a pre-defined list), such as e.g. an office chair or a standing position next to the door. The author can then start to author the flow by placing nodes and connector lines and then can decide to ‘enter’ Performance Editor for any given dialogue node in this flow. In the Performance Editor, the author can for example see the characters and environment the author has configured earlier on and can start author the character performance.

A timeline may be represented by one or more (horizontally) laid out tracks or lanes 630, hosting one or more instances of smart clips (example: 620) of a certain (smart) clip type. An instance may refer to a source smart clip stored on a cloud hosted smart clip repository 560, organized by folder and meta-data. Smart clips may be filtered by relevance using the search function 565. By dragging smart clips (example: 570) from the repository 560 onto a timeline track 630 and assigning a clip to a virtual character 590, a relationship between the smart clip, virtual character and moment in time may be established.

For example, one or more dialog lanes can be defined that can be configured to allow the author to place one or more conversational dialog clips along a timeline of the story line, wherein the one or more conversational dialog clips of the one or more 3D virtual characters can be selected by the author, e.g. from one or more dialog nodes. As another example, one or more performance lanes can be defined that can be configured to allow the author to place one more performance clips, wherein the author selects the one or more performance clips from one or more sets of predefined performance clips. The one or more performance lanes can be one or more of the following: an emotion lane that is configured to allow the author to place one or more emotion clips as performance clips along a timeline of the story line, wherein the author can select the one or more emotional clips from a set of predefined emotional clips; a gesture lane that is configured to allow the author to place one or more gesture clips as performance clips along a timeline of the story line, wherein the author can select the one or more gesture clips from a set of predefined gesture clips; a look at lane that is configured to allow the author to place one or more look at clips as performance clips along a timeline of the story line, wherein the author can select the one or more look at clips from a set of predefined look at clips; and an energy lane that is configured to allow the author to place one or more energy clips as performance clips along a timeline of the story line, wherein the author can select the one or more energy clips from a set of predefined energy clips.

By using the tracks or lanes, the author can focus on the flow in time of the virtual performance, and the use of clips make sure that the logical building blocks immediately result in a scene where the behavior and/or appearance of the virtual characters changes according to the author's wishes.

Gesture Smart Clips can operate within the context of a single timeline; a gesture smart clip starts and stops there. For example, the effect of such a gesture smart clip can be that a virtual character starts waving his/her hands, and then returns to a neutral pose. How long a gesture performs can be dependent on the width of a clip.

Emotions and poses can ‘start’ as well, but they can start a transition towards something else. For example, neutral emotion to anger, or active pose to a lazy/passive pose. The time it takes to transition can be dependent on the size (width) of the Smart Clip. A transition can ‘survive the timeline.’ In other words if the timeline has ended, the pose/emotion can remain the same, and may not revert to a neutral state. Only a new transition somewhere else in the flow (another dialogue node with emotion/pose clips for the same character) may override the current one.

When a Smart Clips starts depends on for example on where it has been placed on a lane, for example at 2 seconds. For example, the more to the right it is dragged on a lane, the further out in time. Here “at 2 seconds” means “at 2 seconds on the current dialogue node.” The node itself might actually trigger for example after 10 minutes, or not at all, depending on how the flow is constructed and what decisions an end-user made to get there. It is dependent on the structure of the flow and how the user ended up at that specific node, i.e. it can be based on the branched narrative.

For example for gestures, the author can also define how quickly the instruction should happen and end (erratic vs smooth). This can be done for example by dragging two key points on the clip horizontally.

When the user interacts with the playback controls 595 or designated keyboard shortcuts, the playback-head 610 may move horizontally from left-to-right. The playback may also be dragged over the timeline using the mouse. When the playback-head reaches the start position of a smart slip (example, 620) or voice-line (600, dialog spoken by a VC), the smart clip may execute the appropriate instructions and animations, rendered as the final 3D performance in the 3D playback window 575. Time indicators (605, 580) provide the user information on the overall timeline time-span, smart clip timing and current time. At the start of the timeline (0:00 seconds), during final playback of the experience, existing emotion and energy states for a virtual character may be inherited from preceding nodes. The user may re-assign smart clips on tracks to other virtual character present in the virtual environment by selecting the icon of a virtual character 590 and selecting a VC from a full list of VC's present in the virtual environment.

Smart Clip strength 615, influencing the expressiveness of an animation and other relevant animation playback data, may be increased or decreased by the user by dragging the horizontal line up or down (0.0 to 1.0). With any clip, the author can define the ‘strength’ (for example excited hand-wave versus a subtle one, a very lazy pose versus a slightly passive one, very angry versus slightly annoyed) by for example dragging such a horizontal line up/down on the clip. Animation easing time may be controlled by the user by dragging a keypoint 610 left or right, with the clip outer edge representing the minimum, and the clip center the maximum. Smart clips may be dragged left and right on current timeline track 630 to adjust the start- and end time. Smart clips may also be dragged onto other tracks accepting the same smart clip type. Smart clip durations may be altered by dragging size handle-bars 635 horizontally, expanding or contracting the smart clip's width.

Voice-lines 600 may be dragged horizontally to change the timing of synthesized, imported or recorded audio. Regions (selections from recorded or imported audio) may be selected by entering the file repository 555 and dragging a region onto a voice-line 600, overriding synthesized text-to-speech. This action may also be reverted back by the user at any time, returning to synthesized text-to-speech.

Hints may be created, modified and/or deleted in flow editor by selecting a dialog node and adding hint data on the properties pane FIG. 3, 130. The user may alter the timing of hints (helper instructions to the user) in performance editor by dragging the clip horizontally on the timeline and by changing the clip duration using size handle-bars.

Stacked smart clips may be played back simultaneously, allowing multiple animations and mesh deformations to occur at the same moment. As an example, a virtual character may transition into the surprised emotion, pointing at the ceiling and leaning forward at the same time by stacking multiple smart clip instances on their respective tracks.

### Region Editor

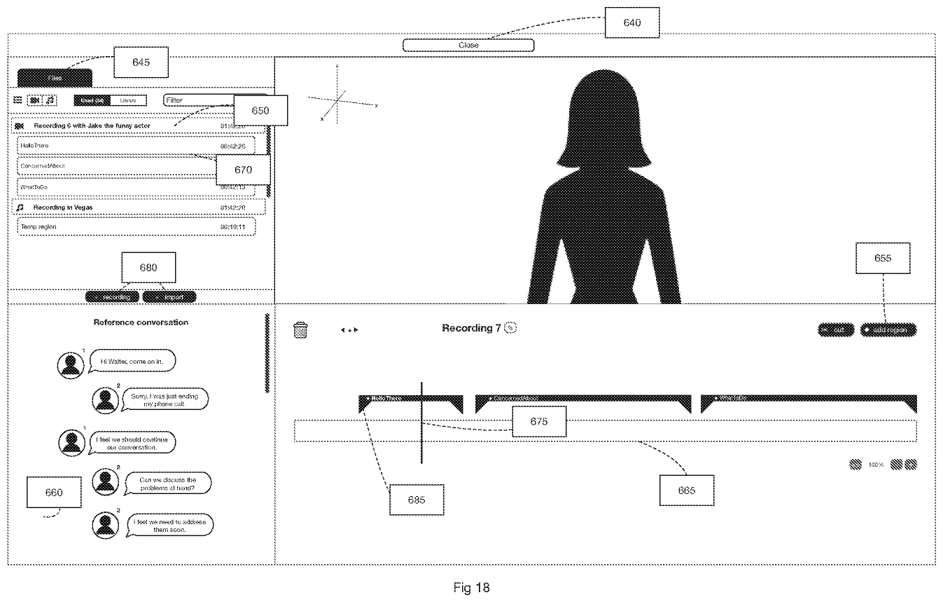

As illustrated in FIG. 18, users import audio files from external data-sources into the project 680 or record audio using the recording editor in performance editor to replace synthesized speech. Once an audio file is imported or recorded, it is added to the project file repository 645. When selecting a recording 650 in the project file repository, the region editor may be displayed. The recording may be visualized as an audio wave-form 665.

By adding one or more regions 655, the user may identify which parts of the audio-waveform are relevant and which parts should be discarded when the project is exported. The regions may be visualized as a horizontal bar with drag handlebars on each side (example: 685). When selecting and moving a drag handlebar horizontally, the selection duration may be increased or decreased. The entire region may be moved by dragging the bar horizontally on the audio wave-form. The regions may be labeled with a custom name. Regions 670 may be listed in the project file repository, and grouped by the related audio file 650. Regions may be dragged onto voice-lines (an example is shown in FIG. 17 item 600) in the main performance editor view, replacing automatically generated synthesized speech. The dialog node VC copy 660 may be displayed to aid the user in the creation and customization of regions.

The playback-head is similar in function to the main timeline section of performance editor, and may be used to playback the audio-file. Returning to the main timeline section of the performance editor may be done by clicking a button 640.

### Recording Editor

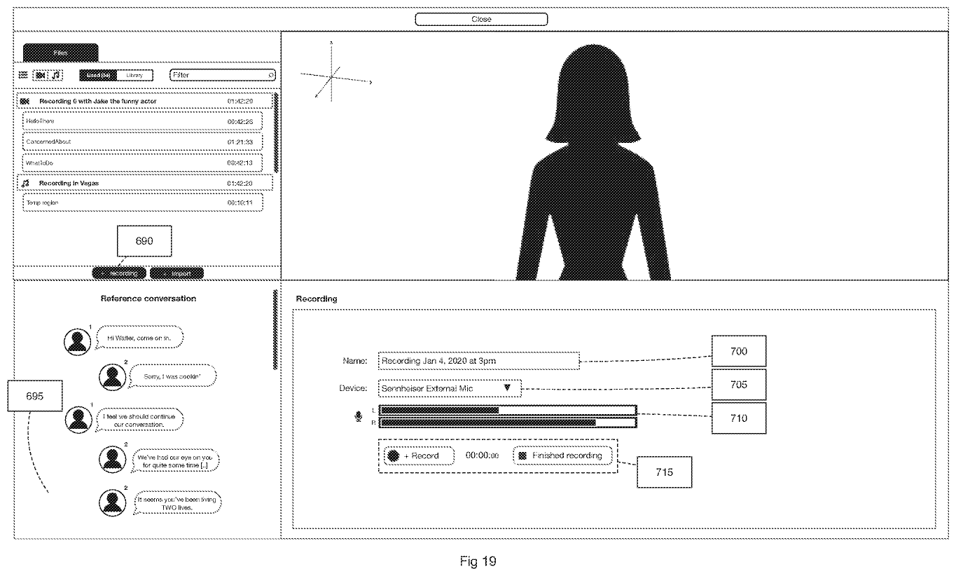

FIG. 19 illustrates an exemplary recording editor. The recording editor may be used for users to record audio-files using a computer's recording device, or external microphone input devices. By selecting the recording button 690, the recording editor may be displayed. A new recording may be started and stopped by using the recording control buttons 715. During recording the duration may be displayed. The user may label a recording with a custom name 700. The recording device may be selected before a recording session 705. Recording volume may be reviewed by monitoring the volume mixer 710, where a green color represents a recording volume that is not clipped (distorted), an orange color represents the volume nearing the clipping range (loud volume), and red representing audio that is clipped, leading to distorted sound. The dialog node VC copy 695 is displayed to aid the user in the creation and customization of regions.

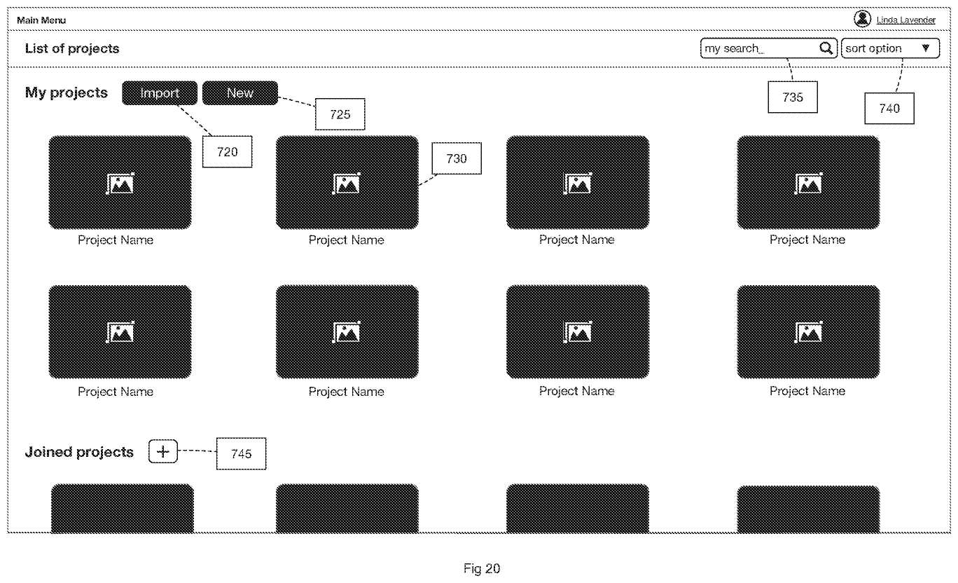

Designer may store projects in a database format on the user's local storage medium and on the centralized server (see FIG. 20). Projects may be configured by the user in the project setup section of the tool. As illustrated in FIG. 20, projects may be created by selecting the new function 725 or imported from external sources by selecting the import function 720. Projects may be exported to the local storage medium or downloaded by the branched flow player FIG. 1, 15 for playback. As illustrated in FIG. 20, projects may be listed as thumbnails 745 and the visual representation of the thumbnails may be configured by the user by selecting an image from the user local storage medium. Projects may be filtered from a larger list by using the search 740 and filter 735 function. Tool users may invite other users to their project with administrative, comment and/or view permissions. Projects the user is invited to may be listed separately 745 from projects created by the user. Projects may be deleted by selecting a thumbnail and triggering the ‘delete’ function.

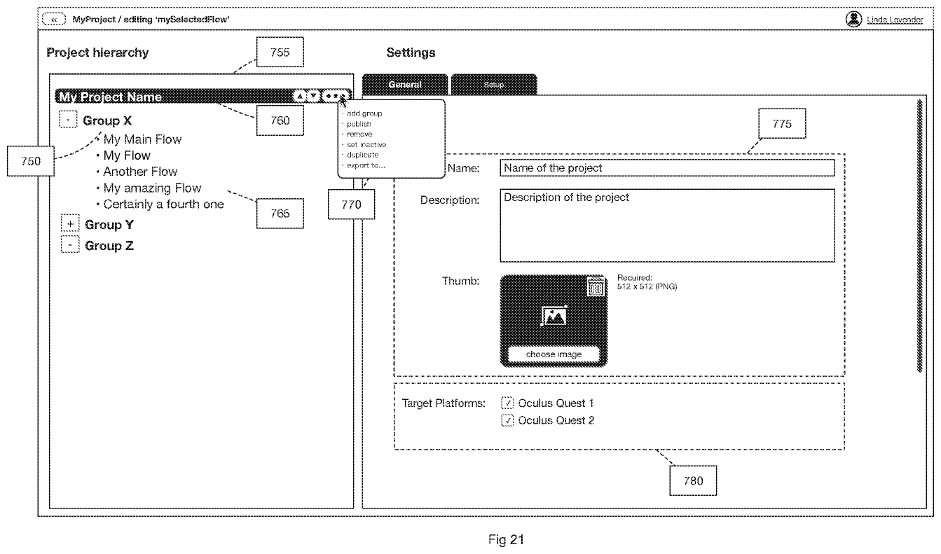

A project contains 1-to-n flows 765 and 1-to-n groups 750, listed in the project hierarchy window 755 (see for example, FIG. 21). Flows may be assigned to a group created by the user. A group, when played back using BFP, may be represented as a selection to the user. When the user selects a group during playback, a sub-menu may expand, displaying the flows assigned to the group. An example is a group of lessons about a specific topic, with the group containing an introductory course (flow A) and an advanced course (flow B). Depending on the selection in the project hierarchy window (project, group or flow), the user is presented configuration options related to the selection. As illustrated in FIG. 21, when the project 760, group 750 or flow 765 is selected, the user may define an optional name, description and/or visual representation 775. When the project 760 is selected, the user may define which target hardware platform the project requires to support 780. Designer may apply constraints based on this selection, including the maximum Virtual characters allowed in a flow. The user may apply actions on an element in the project hierarchy window 750. Actions may be available or locked based on the selected element and/or active user permissions.

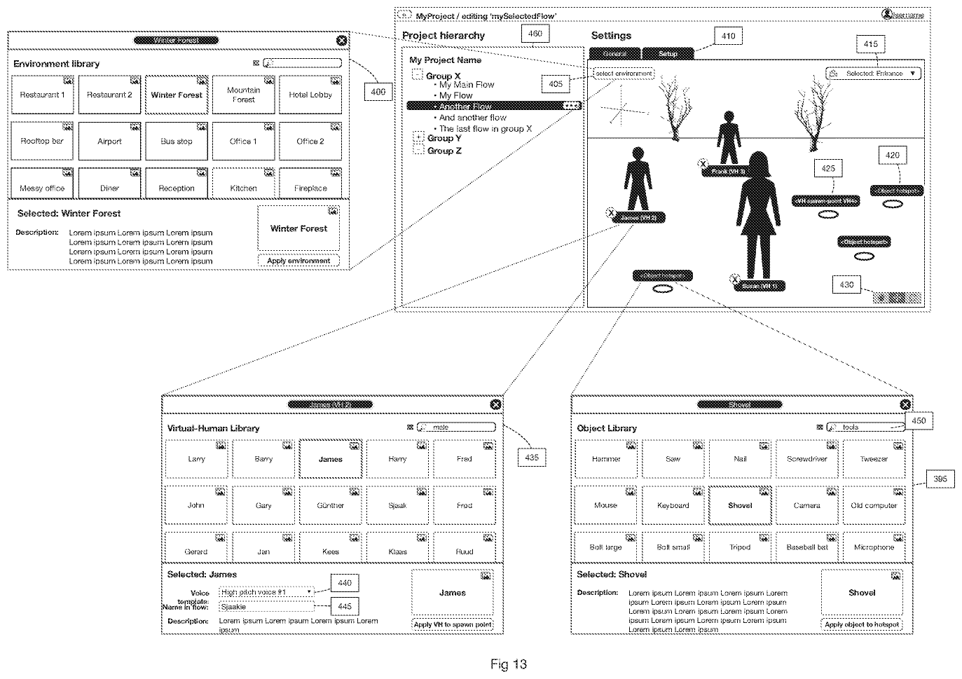

Environment setup is activated when the user selects a flow from the project hierarchy window 460 and the setup tab 400 is active. An example is illustrated in FIG. 13. A flow may reference one or more of the following: a virtual environment, 1-to-n virtual characters, and 1-to-n virtual objects. The user may select a virtual environment by using the applicable function 405 and choosing from a repository of virtual environments 400 that may be stored on the server (FIG. 1, 15). As illustrated in FIG. 13, the user may add one or more virtual characters by selecting a predefined spawn-point 425 and choosing from a repository of virtual characters 435 that may be stored on the server (FIG. 1, 15). The desired voice-template 440 may be assigned to the selected VH, affecting the synthesized voice output (characterized by variables including gender, race, voice pitch, timbre, et cetera). The user may define a name 445 for the selected virtual character exposed in the flow editor, the performance editor, and/or the BFP. As illustrated in FIG. 13, the user may add one or more virtual objects by selecting a predefined object hotspot 420 and choosing from a repository of virtual objects 395 that may be stored on the server (FIG. 1, 15). The user may rotate and/or resize virtual objects. The user may navigate the 3D environment by using the camera control functions 430.

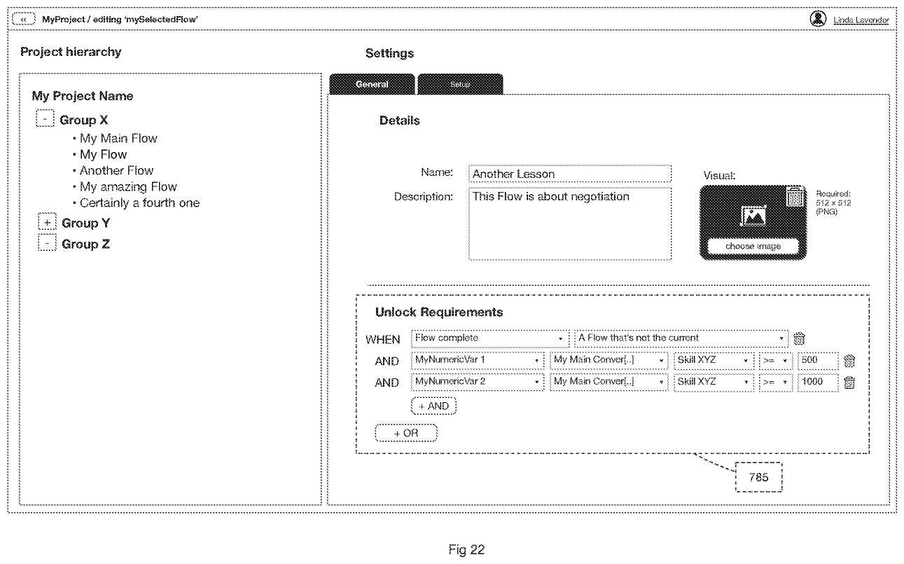

Flows may be access-locked by default when playing back using BFP (see for example FIG. 22). The user may define the requirements for flows to become accessible in the unlock requirements window. Requirements may be defined by creating conditional statements 785. The user may construct conditions by adding AND or OR statements with evaluation criteria using variables created in flow editor (FIG. 3, 145). When defined conditions are ‘TRUE’, the flow becomes accessible to the end-user.

An example of a designer exposes export functionality in project setup is provided below in table 2.

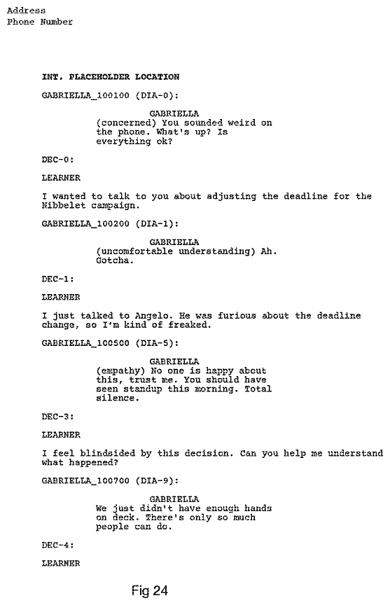

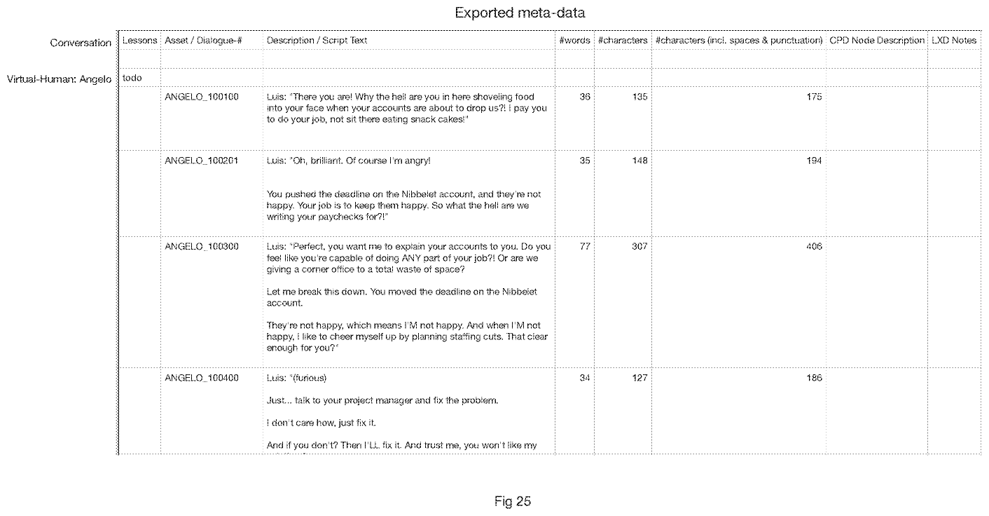

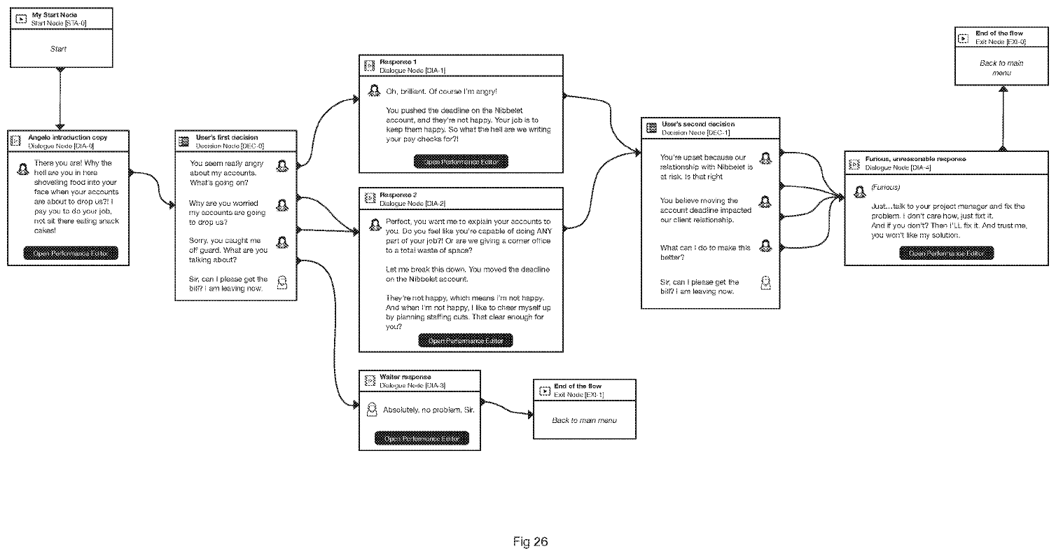

TABLE 2

| Function | Output |
|---|---|
| Export | The project is exported to a user designated storage medium. Exported projects may |
| Project | be imported into the tool. Project files with a deprecated data structure are upgraded |
| | upon import. |
| Publish | Projects stored on the server (FIG. 1, 25) are flagged for review by an administrator |
| Project | and duplicated to a staging server. When the review is successful, the project is |
| | moved from the staging server to a live server, and becomes accessible to be |
| | experienced by users with the applicable viewing permissions on the target |
| | hardware device through the BFP (FIG. 1, 10). |
| Screenplay | Linked, sequential nodes selected by the user in flow editor are exported as marked- |
| | up text files. (Example: FIG. 24). The output describes the movement, actions, |
| | expression and dialogs of the virtual characters, and decision points of the user. |
| CSV | Comma- and tab delimited files containing dialog-, decision-, and briefing copy of |
| | the selected flows (Example: FIG. 25). |
| Flow image | A high-resolution representation of the selected flows and flows inside sub- |
| | components. (Example output: FIG. 26) |

### Computer System

In exemplary embodiments, one or more computer systems perform one or more steps of one or more methods described or disclosed herein. In exemplary embodiments, one or more computer systems provide functionality described or shown in this disclosure. In exemplary embodiments, software configured to be executable running on one or more computer systems performs one or more steps of one or more methods disclosed herein and/or provides functionality disclosed herein. Reference to a computer system may encompass a computing device, and vice versa, where appropriate. Moreover, reference to a computer system may encompass one or more computer systems, where appropriate.

This disclosure contemplates a suitable number of computer systems. As example and not by way of limitation, computer system may be an embedded computer system, a system-on-chip (SOC), a single-board computer system (SBC) (such as, for example, a computer-on-module (COM) or system-on-module (SOM)), a desktop computer system, a laptop or notebook computer system, a main-frame, a mesh of computer systems, a personal digital assistant (PDA), a server, a tablet computer system, an augmented/virtual reality device, or a combination of thereof. Where appropriate, computer system may include one or more computer systems; be unitary or distributed; span multiple locations; span multiple machines; span multiple data centers; or reside in a cloud, which may include one or more cloud components in one or more networks. Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods disclosed herein.

The computer system may include a processor, memory, storage, an input/output (I/O) interface, a communication interface, and a bus.

The processor may include hardware for executing instructions, such as those making up a computer program. As an example, and not by way of limitation, to execute instructions, processor may retrieve the instructions from an internal register, an internal cache, memory, or storage; decode and execute them; and then write one or more results to an internal register, an internal cache, memory, or storage. The processor may include one or more internal caches for data, instructions, or addresses. This disclosure contemplates processor including a suitable number of suitable internal caches, where appropriate. The processor may include one or more instruction caches, one or more data caches, and one or more translation lookaside buffers (TLBs). Instructions in the instruction caches may be copies of instructions in memory or storage, and the instruction caches may speed up retrieval of those instructions by processor.

The memory may include main memory for storing instructions for processor to execute or data for processor to operate on. The computer system may load instructions from storage or another source (such as, for example, another computer system) to memory. Processor may then load the instructions from memory to an internal register or internal cache. To execute the instructions, processor may retrieve the instructions from the internal register or internal cache and decode them. During or after execution of the instructions, processor may write one or more results (which may be intermediate or final results) to the internal register or internal cache. Processor may then write one or more of those results to memory. The processor executes only instructions in one or more internal registers or internal caches or in memory (as opposed to storage or elsewhere) and operates only on data in one or more internal registers or internal caches or in memory (as opposed to storage or elsewhere). One or more memory buses may couple processor to memory. Bus may include one or more memory buses. The memory may include random access memory (RAM). This RAM may be volatile memory, where appropriate Where appropriate, this RANI may be dynamic RAM (DRAM) or static RANI (SRAM). Moreover, where appropriate, this RANI may be single-ported or multi-ported RAM. Memory may include one or more memories, where appropriate.

The storage may include mass storage for data or instructions. The storage may include a hard disk drive (HDD), flash memory, an optical disc, a magneto-optical disc, magnetic tape, or a Universal Serial Bus (USB) drive or a combination therein. Storage may include removable or non-removable (or fixed) media, where appropriate. Storage may be internal or external to computer system, where appropriate. Storage may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination thereof.

In particular embodiments, I/O interface (x) may include hardware, software, or both, providing one or more interfaces for communication between computer system and one or more I/O devices. Computer system may include one or more of these I/O devices, where appropriate. One or more of these I/O devices may enable communication between a person and computer system. An I/O device may include a keyboard, keypad, microphone, monitor, mouse, printer, scanner, speaker, still camera, stylus, tablet, touch screen, trackball, video camera, another suitable I/O device or a combination thereof. An I/O device may include one or more sensors. This disclosure contemplates any suitable I/O devices and any suitable I/O interfaces for them. Where appropriate, I/O interface may include one or more device or software drivers enabling processor to drive one or more of these I/O devices. I/O interface may include one or more I/O interfaces, where appropriate.

Further advantages of the claimed subject matter will become apparent from the following examples describing certain embodiments of the claimed subject matter.

### Example 1A

A non-transitory machine-readable medium storing a performance editing application that allows an author to create a visual performance for one or more 3D virtual characters in a story line, the performance editing application comprising:
a first tool that is configured to allow the author to select one or more 3D virtual characters from a predefined set of virtual characters, and one or more virtual environments from a predefined set of virtual environments and add to a display area;
the display area for displaying at least in part the visual performance of one or more 3D virtual characters in the story line; and
in the display area:
   defining a dialog lane that is configured to allow the author to place one or more conversational dialog clips along a timeline of the story line, wherein the one or more conversational clips of the one or more 3D virtual characters are selected by the author from one or more dialog nodes,
   defining one or more performance lanes that are configured to allow the author to place one more performance clips, wherein the author selects the one or more performance clips from one or more sets of predefined performance clips; and
an animating tool that is configured to animate the one or more 3D virtual characters and the one or more virtual environments at least in part by data authored in the timeline of the story line by associating the one or more 3D virtual characters and the one or more virtual environments with data from the dialog lane and from the one or more performance lanes;
wherein the performance editing application is configured to allow the author with minimal coding expertise, minimal skills in voice-acting, minimal animation design, minimal 3D modeling or combinations thereof to create the visual components of the one or more 3D virtual characters that are capable of being used in an interactive narrative.

### 2A

A non-transitory machine-readable medium storing a performance editing application that allows an author to create a visual performance for one or more 3D virtual characters in a story line, the performance editing application comprising:
a first tool that is configured to allow the author to select one or more 3D virtual characters from a predefined set of virtual characters, and one or more virtual environments from a predefined set of virtual environments and add to a display area;
the display area for displaying at least in part the visual performance of one or more 3D virtual characters in the story line; and
in the display area:
   defining a dialog lane that is configured to allow the author to place one or more conversational dialog clips along a timeline of the story line, wherein the one or more conversational clips of the one or more 3D virtual characters are selected by the author from one or more dialog nodes;
   defining an emotion lane that is configured to allow the author to place one or more emotion clips along a timeline of the story line, wherein the author selects the one or more emotional clips from a set of predefined emotional clips;
   defining a gesture lane that is configured to allow the author to place one or more gesture clips along a timeline of the story line, wherein the author selects the one or more gesture clips from a set of predefined gesture clips;
   defining a look at lane that is configured to allow the author to place one or more look at clips along a timeline of the story line, wherein the author selects the one or more look at clips from a set of predefined look at clips;
   defining an energy lane that is configured to allow the author to place one or more energy clips along a timeline of the story line, wherein the author selects the one or more energy clips from a set of predefined energy clips; and
an animating tool that is configured to animate the one or more 3D virtual characters and the one or more virtual environments a least in part by data authored in the timeline of the story line by associating the one or more 3D virtual characters and the one or more virtual environments with data from one or more of the following: the dialog lane, the emotion lane, the gesture lane, the look at lane and the energy lane;
wherein the performance editing application is configured to allow the author with minimal coding expertise, minimal skills in voice-acting, minimal animation design, minimal 3D modeling or combinations thereof to create the visual components of the one or more 3D virtual characters that are capable of being used in an interactive narrative.

### 3A

The non-transitory machine-readable medium storing a performance editing application of example 1A, wherein the one or more performance lanes is one or more of the following:
an emotion lane that is configured to allow the author to place one or more emotion clips along a timeline of the story line, wherein the author selects the one or more emotional clips from a set of predefined emotional clips;
a gesture lane that is configured to allow the author to place one or more gesture clips along a timeline of the story line, wherein the author selects the one or more gesture clips from a set of predefined gesture clips;
a look at lane that is configured to allow the author to place one or more look at clips along a timeline of the story line, wherein the author selects the one or more look at clips from a set of predefined look at clips; and
an energy lane that is configured to allow the author to place one or more energy clips along a timeline of the story line, wherein the author selects the one or more energy clips from a set of predefined energy clips.

### 4A

The non-transitory machine-readable medium storing a performance editing application of any of examples 1A to 3A, wherein the application is configured to allow the author to insert one or more smart clips at one or more time periods of the story line.

### 5A

The non-transitory machine-readable medium storing a performance editing application of example 4A, wherein the one or more smart clips are configured to be used to direct a 3D virtual character's performance.

### 6A

The non-transitory machine-readable medium storing a performance editing application of examples 4A or 5A, wherein the one or more smart clips are configured to be used to change the 3D virtual character performance in real time with respect to one or more of the following: an emotional state, a body pose, an energy state, and a body gesture.

### 7A

The non-transitory machine-readable medium storing a performance editing application of any of examples 4A to 6A, wherein the application is configured to automatically allow one or more smart clips to be triggered in real time based at least in part on the one or more human end users input.

### 8A

The non-transitory machine-readable medium storing a performance editing application of any of examples 1A to 7A, wherein the one or more human end users input includes one or more of the following: speech emotion, heart-rate, blood pressure, eye pupil motion and dilation, and temperature.

### 9A

The non-transitory machine-readable medium storing a performance editing application of any of examples 1A to 8A, wherein the application's emotion lane is configured to allow a persistent transition from a current emotional state of the one or more 3D virtual characters to a destination emotional state at one or more time periods of the story line.

### 10A

The non-transitory machine-readable medium storing a performance editing application of any of examples 1A to 9A, wherein the application is configured to allow an emotional state of the one or more 3D virtual characters to affect one or more of the following: a speech synthesis output, one or more facial expressions, one or more gestures, one or more poses, and an idle behavior.

### 11A

The non-transitory machine-readable medium storing a performance editing application of any of examples 1A to 10A, wherein the application's energy lane is configured to allow a persistent transition from a current energy state of the one or more 3D virtual characters to a destination energy state of the one or more 3D virtual characters at one or more time periods of the story line.

### 12A

The non-transitory machine-readable medium storing a performance editing application of any of examples 1A to 11A, wherein the application is configured to allow an energy state of the one or more 3D virtual characters to affect one or more of the following the one or more body poses, the one or more gestures, the speech synthesis output, and the idle behavior.

### 13A

The non-transitory machine-readable medium storing a performance editing application of any of examples 1A to 12A, wherein the application's gesture lane is configured to allow a persistent transition from a current gesture state of the one or more 3D virtual characters to a destination gesture state of the one or more 3D virtual characters at one or more time periods of the story line.

### 14A

The non-transitory machine-readable medium storing a performance editing application of any of examples 1A to 13A, wherein the application is configured to allow a gesture state of the one or more 3D virtual characters to affect one or more of the following: a face, a head, an upper body, a hand, an arm, a foot, and a lower body part.

### 15A

The non-transitory machine-readable medium storing a performance editing application of any of examples 1A to 14A, wherein each of the dialog lanes is configured to allow the author to place one or more conversational dialog clips along a timeline of the story line, wherein the one or more conversational clips of the 3D virtual characters is selected by the author from one or more dialog nodes.

### 16A

The non-transitory machine-readable medium storing a performance editing application of any of examples 1A to 15A, wherein a predefined gesture clip includes instructions to the one or more 3D virtual characters as to where to look when performing the gesture.

### 17A

The non-transitory machine-readable medium storing a performance editing application of any of examples 1A to 16A, wherein the application is configured to allow the author the ability to alter the placement along the time line of the story line of one or more of the following: the one or more conversational dialog clips, the one or more emotion clips, the one or more gesture clips, the one or more look at clips, the one or more energy clips, and the one or more smart clips.

### 18A

The non-transitory machine-readable medium storing a performance editing application of any of examples 1A to 17A, wherein the interactive narrative is in real time.

### 19A

The non-transitory machine-readable medium storing a performance editing application of any of examples 1A to 18A, wherein the animating tool that is a virtual-character animation engine.

### 20A

A system comprising:
one or more processors;
one or more memories coupled to the one or more processors;
a display comprising a display area and coupled to the one or processors;
a non-transitory machine-readable performance editing application stored in the one or more memories, the performance editing application is configured to allow an author to create a visual performance for one or more 3D virtual characters in a story line, the performance editing application comprising:
a first tool that is configured to allow the author to select one or more 3D virtual characters from a predefined set of virtual characters, and one or more virtual environments from a predefined set of virtual environments and add to a display area;
the display area for displaying at least in part the visual performance of one or more 3D virtual characters in the story line; and
in the display area:
   defining a dialog lane that is configured to allow the author to place one or more conversational dialog clips along a timeline of the story line, wherein the one or more conversational clips of the one or more 3D virtual characters are selected by the author from one or more dialog nodes;
   defining an emotion lane that is configured to allow the author to place one or more emotion clips along a timeline of the story line, wherein the author selects the one or more emotional clips from a set of predefined emotional clips;
   defining a gesture lane that is configured to allow the author to place one or more gesture clips along a timeline of the story line, wherein the author selects the one or more gesture clips from a set of predefined gesture clips;
   defining a look at lane that is configured to allow the author to place one or more look at clips along a timeline of the story line, wherein the author selects the one or more look at clips from a set of predefined look at clips;
   defining an energy lane that is configured to allow the author to place one or more energy clips along a timeline of the story line, wherein the author selects the one or more energy clips from a set of predefined energy clips; and
an animating tool that is configured to animate the one or more 3D virtual characters and the one or more virtual environments a least in part by data authored in the timeline of the story line by associating the one or more 3D virtual characters and the one or more virtual environments with data from one or more of the following: the dialog lane, the emotion lane, the gesture lane, the look at lane and the energy lane;
wherein the performance editing application is configured to allow the author with minimal coding expertise, minimal skills in voice-acting, minimal animation design, minimal 3D modeling or combinations thereof to create the visual components of the one or more 3D virtual characters that are capable of being used in an interactive narrative.

### 21A

A system comprising: one or more processors; and one or more memories coupled to the one or more processors comprising instructions executable by the one or more processors, the one or more processors being operable when executing the instructions to implement any of examples 1A to 19A.

### 22A

A method of using a non-transitory machine-readable medium storing a performance editing application to allow and author to create a visual performance for one or more 3D virtual characters in a story line, comprising the steps of:
using a first tool that allows the author to select one or more 3D virtual characters from a predefined set of virtual characters, and one or more virtual environments from a predefined set of virtual environments;
adding the select one or more 3D virtual characters and the one or more virtual environments to a display area and displaying the select one or more 3D virtual characters and the one or more virtual environments in the display area;
defining a dialog lane in the display area and allowing the author to place one or more conversational dialog clips along a timeline of the story line, wherein the one or more conversational clips of the one or more 3D virtual characters are selected by the author from one or more dialog nodes;
defining an emotion lane in the display area and allowing the author to place one or more emotion clips along a timeline of the story line, wherein the author selects the one or more emotional clips from a set of predefined emotional clips;
defining a gesture lane in the display area and allowing the author to place one or more gesture clips along a timeline of the story line, wherein the author selects the one or more gesture clips from a set of predefined gesture clips;
defining a look at lane in the display area allowing the author to place one or more look at clips along a timeline of the story line, wherein the author selects the one or more look at clips from a set of predefined look at clips;
defining an energy lane in the display area and allowing the author to place one or more energy clips along a timeline of the story line, wherein the author selects the one or more energy clips from a set of predefined energy clips; and
using an animating tool to animate the one or more 3D virtual characters and the one or more virtual environments a least in part by data authored in the timeline of the story line by associating the one or more 3D virtual characters and the one or more virtual environments with data from one or more of the following: the dialog lane, the emotion lane, the gesture lane, the look at lane and the energy lane; wherein the performance editing application is configured to allow the author with minimal coding expertise, minimal skills in voice-acting, minimal animation design, minimal 3D modeling or combinations thereof to create the visual components of the one or more 3D virtual characters that are capable of being used in an interactive narrative.

### 1B

A non-transitory machine-readable medium storing an interactive branched flow editing application that allows an author to create a story line with interactive script and one or more 3D virtual characters, the branch flow editing application comprising:
a display area for displaying at least one or more of the following: the one or more 3D virtual characters, one or more virtual environments, and an interactive dialog for the one or more 3D virtual characters;
a start tool that is configured to allow the author to create a start node, wherein the start node is configured to start the story line;
a dialog tool that is configured to allow the author to enter conversational dialog into at least one dialog node, wherein the conversational dialog is used to trigger audio by the 3D virtual character; an exit tool that is configured to allow the author to enter an exit to the story line in an exit node; and
a connecting tool that is configured to allow the author to connect one or more nodes by connector lines to create a story line logic within the story line;
wherein the branch flow editing application is configured to allow the author with minimal coding expertise, minimal skills in voice-acting, minimal animation design, minimal 3D modeling or combinations thereof to create an interactive branch flow narrative.

### 2B

The non-transitory machine-readable medium storing an interactive branched flow editing application of example 1B, wherein the branch flow player further comprises a decision point tool that is configured to allow the author to create decision points in the interactive branch flow of the story line.

### 3B

The non-transitory machine-readable medium storing an interactive branched flow editing application of examples 1B or 2B, wherein the branch flow player further comprises a conditional statement tool that is configured to allow the author to enter conditional statements in a conditional node of the story line.

### 4B

The non-transitory machine-readable medium storing an interactive branched flow editing application of any of examples 1B to 3B, wherein the branch flow player further comprises a playing tool that is configured to allow the playing of the story line.

### 5B

The non-transitory machine-readable medium storing an interactive branched flow editing application of example 4B, wherein the playing tool is a branch flow player.

### 6B

The non-transitory machine-readable medium storing an interactive branched flow editing application of examples 4B or 5B, wherein the playing tool is configured to permit the one or more 3D virtual characters to interact with the one or more human end users according to what is authored in the story line.

### 7B

The non-transitory machine-readable medium storing an interactive branched flow editing application of any of examples 1B to 6B, wherein the audio is synthesized speech, imported recording speech or combinations thereof.

### 8B

The non-transitory machine-readable medium storing an interactive branched flow editing application of any of examples 1B to 7B, wherein the application is configured to allow the author to insert one or more smart clips at one or more time periods of the story line.

### 9B

The non-transitory machine-readable medium storing an interactive branched flow editing application of example 8B, wherein the one or more smart clips are configured to be used to direct a 3D virtual character's performance.

### 10B

The non-transitory machine-readable medium storing an interactive branched flow editing application of examples 8B or 9B, wherein the one or more smart clips are configured to be used to change the 3D virtual character performance in real time with respect to one or more of the following: an emotional state, a body pose, an energy state, and a body gesture.

### 11B

The non-transitory machine-readable medium storing an interactive branched flow editing application of any of examples 8B to 10B, wherein the application is configured to automatically allow one or more smart clips to be triggered in real time based at least in part on the one or more human end users input.

### 12B

The non-transitory machine-readable medium storing an interactive branched flow editing application of any of examples 1B to 11B, wherein the application is configured to allow the author to construct a plurality of branch flows.

### 13B

The non-transitory machine-readable medium storing an interactive branched flow editing application of any of examples 1B to 12B, wherein the application is configured to allow a visual construction of one or more branch flows.

### 14B

The non-transitory machine-readable medium storing an interactive branched flow editing application of any of examples 1B to 13B, wherein the application is configured to allow 1-to-n of the one or more branch flows.

### 15B

The non-transitory machine-readable medium storing an interactive branched flow editing application of any of examples 1B to 14B, wherein the application is configured to allow flows that are daisy-chained in structure.

### 16B

The non-transitory machine-readable medium storing an interactive branched flow editing application of any of examples 1B to 15B, wherein the application is configured to allow one or more global variables, one or more local variables, or combinations thereof.

### 17B

The non-transitory machine-readable medium storing an interactive branched flow editing application of any of examples 1B to 16B, wherein the application further comprises a random tool that based on the weighted randomization criteria set by the author causes the branch to be directed to one or more applicable out-points.

### 18B

The non-transitory machine-readable medium storing an interactive branched flow editing application of any of examples 1B to 17B, wherein the application further comprises a message tool.

### 19B

The non-transitory machine-readable medium storing an interactive branched flow editing application of any of examples 1B to 18B, wherein the application further comprises a scoring tool.

### 20B

The non-transitory machine-readable medium storing an interactive branched flow editing application of any of examples 1B to 19B, wherein the application is configured to allow the author to insert one or more story lines within a story line.

### 21B

A system comprising: one or more processors; and one or more memories coupled to the one or more processors comprising instructions executable by the one or more processors, the one or more processors being operable when executing the instructions to implement any of examples 1B to 20B.

### 22B

A system comprising:
one or more processors;
one or more memories coupled to the one or more processors;
a display comprising a display area and coupled to the one or processors;
a non-transitory machine-readable medium storing an interactive branched flow editing application that allows an author to create a story line with interactive script and one or more 3D virtual characters, the branch flow editing application comprising:

the display area is configured to display at least one or more of the following: the one or more 3D virtual characters, one or more virtual environments, and an interactive dialog for the one or more 3D virtual characters;
a start tool that is configured to allow the author to create a start node, wherein the start node is configured to start the story line;
a dialog tool that is configured to allow the author to enter conversational dialog into at least one dialog node, wherein the conversational dialog is used to trigger audio by the 3D virtual character;
a decision point tool that is configured to allow the author to create decision points in the interactive branch flow of the story line;
a conditional statement tool that is configured to allow the author to enter conditional statements in a conditional node of the story line;
an exit tool that is configured to allow the author to enter an exit to the story line in an exit node;
a connecting tool that is configured to allow the author to connect one or more nodes by connector lines to create a story line logic within the story line; and a conditional statement tool that is configured to allow the author to enter conditional statements in a conditional node of the story line;
wherein the system is configured to allow the author with minimal coding expertise, minimal skills in voice-acting, minimal animation design, minimal 3D modeling or combinations thereof to create an interactive branch flow narrative.

### 23B

A method of using a non-transitory machine-readable medium storing an interactive branched flow editing application that allows an author to create a story line with interactive script and one or more 3D virtual characters, the branch flow editing application comprising the steps of: using a display area to display at least one or more of the following: the one or more 3D virtual characters, one or more virtual environments, and an interactive dialog for the one or more 3D virtual characters;
using a start tool that allows the author to create a start node, wherein the start node is configured to start the story line;
using a dialog tool that allows the author to enter conversational dialog into at least one dialog node, wherein the conversational dialog is used to trigger audio by the 3D virtual character;
using a decision point tool that allows the author to create decision points in the interactive branch flow of the story line;
using a conditional statement tool that allows the author to enter conditional statements in a conditional node of the story line;
using an exit tool that allows the author to enter an exit to the story line in an exit node;
using a connecting tool that allows the author to connect one or more nodes by connector lines to create a story line logic within the story line; and
using a conditional statement tool that allows the author to enter conditional statements in a conditional node of the story line;
wherein the method is configured to allow the author with minimal coding expertise, minimal skills in voice-acting, minimal animation design, minimal 3D modeling or combinations thereof to create an interactive branch flow narrative.

### 1C

A system for automatically adjusting a virtual character's reactions based at least in part on the virtual character's interaction with a human character in a narrative interactive story line, comprising:
a display device;
one or more processors;
memory, the memory includes a one or more nodes that are configured to store input elements selected from one or more of the following: one or more virtual characters, one or more virtual environments, one or more facial expressions, one or more character poses, one or more voice activated dialog, and one or more character behaviors;
the story line stored in memory comprises input elements selected by the author from the one or more nodes that are mapped to one or more time periods in the story line and associated with each other
to the one plurality of facial expressions, the plurality of poses, and the plurality of behaviors associated with the virtual character at the one or more time periods in the story line, the input elements initially selectable by an author to select a facial expression, a pose, and a behavior for the virtual character;
the one or more processors are configured to be operable, via machine-readable instructions stored in the memory, to:
display the story line on the display device and the virtual character is configured to interact with a human as the story line progress in real time, wherein the story line displays one or more poses, one or more voice activated text, one or more facial expressions, one or more behaviors associated with the virtual character at the one or time periods in the story line;
the story line being activated by a user-selected behavior for the virtual character and provide in real time an animation of movement of the virtual character from a prior position to a position exhibiting the one or more user-selected facial expression, one or more user-selected pose, and one or more user-selected behavior, and display in real time, on the display device;
wherein the machine-readable instructions are configured to automatically adjust the virtual character's the one or more poses, the one or more voice activated text, the one or more facial expressions, the one or more behaviors based at least in part on the level of emotional interaction between the virtual character and the human.

### 1D

A system comprising:
one or more processors;
one or more memories coupled to the one or more processors;
a display comprising a display area and coupled to the one or more processors;
a non-transitory machine-readable medium storing a virtual character authoring system comprising: a performance editing application that is configured to allow an author to create a visual performance for one or more 3D virtual characters in a story line;
an interactive branched flow editing application that is configured to allow an author to create a story line with interactive script and one or more 3D virtual characters;
a virtual-human animation engine application that is configured to allow animation of the one or more 3D virtual characters; and
a branched flow player application that is configured to allow interpretation and running of content the visual performance;
wherein the virtual character authoring system is configured to allow the author with minimal coding expertise, skills in voice-acting, animation design, 3D modeling or combinations thereof to create a story line that is capable of being played in an interactive setting between the one or more 3D virtual characters and one or more human end users.

### 2D

A method comprising:
using one or more processors;
using one or more memories coupled to the one or more processors;
using a display comprising a display area and coupled to the one or more processors;
using a non-transitory machine-readable medium storing a virtual character authoring system comprising:
a performance editing application that is configured to allow an author to create a visual performance for one or more 3D virtual characters in a story line;
an interactive branched flow editing application that is configured to allow an author to create a story line with interactive script and one or more 3D virtual characters;
a virtual-human animation engine application that is configured to allow animation of the one or more 3D virtual characters; and a branched flow player application that is configured to allow interpretation and running of content the visual performance;
wherein the method allows the author with minimal coding expertise, skills in voice-acting, animation design, 3D modeling or combinations thereof to create a story line that is capable of being played in an interactive setting between the one or more 3D virtual characters and one or more human end users.

### 3D

A non-transitory machine-readable medium storing a virtual character authoring system that allows an author to create a story line with interactive script and one or more 3D virtual characters, the virtual character authoring system comprising:
a performance editing application that is configured to allow an author to create a visual performance for one or more 3D virtual characters in a story line;
an interactive branched flow editing application that is configured to allow an author to create a story line with interactive script and one or more 3D virtual characters;
a virtual-human animation engine application that is configured to allow animation of the one or more 3D virtual characters; and
a branched flow player application that is configured to allow interpretation and running of content the visual performance;
wherein the virtual character authoring system is configured to allow the author with minimal coding expertise, skills in voice-acting, animation design, 3D modeling or combinations thereof to create a story line that is capable of being played in an interactive setting between the one or more 3D virtual characters and one or more human end users.

This disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The following description is provided in relation to several embodiments that may share common characteristics and features. It is to be understood that one or more features of one embodiment may be combined with one or more features of other embodiments. In addition, a single feature or combination of features in certain of the embodiments may constitute additional embodiments. Specific structural and functional details disclosed herein are not to be interpreted as limiting, but merely as a representative basis for teaching one skilled in the art to variously employ the disclosed embodiments and variations of those embodiments.

What is claimed is:

1. A non-transitory machine-readable medium storing a performance editing application that allows an author to create a visual performance for one or more 3D virtual characters in a story line, the performance editing application comprising:
a first tool that is configured to allow the author to select one or more 3D virtual characters from a predefined set of virtual characters, and one or more virtual environments from a predefined set of virtual environments and add to a display area;
the display area for displaying at least in part the visual performance of one or more 3D virtual characters in the story line; and
in the display area:
defining one or more dialog lanes that are configured to allow the author to place one or more conversational dialog clips along a timeline of the story line, wherein the one or more conversational dialog clips of the one or more 3D virtual characters are selected by the author,
defining one or more performance lanes that are configured to allow the author to place one more performance clips, wherein the author selects the one or more performance clips from one or more sets of predefined performance clips; and
an animating tool that is configured to animate the one or more 3D virtual characters and the one or more virtual environments at least in part by data authored in the timeline of the story line by associating the one or more 3D virtual characters and the one or more virtual environments with data from the one or more dialog lanes and from the one or more performance lanes;
such that the performance editing application allows the author to create the visual components of the one or more 3D virtual characters that are capable of being used in an interactive narrative.

2. The non-transitory machine-readable medium storing a performance editing application of claim 1, wherein the one or more performance lanes is one or more of the following:
an emotion lane that is configured to allow the author to place one or more emotion clips as performance clips along a timeline of the story line, wherein the author selects the one or more emotional clips from a set of predefined emotional clips;
a gesture lane that is configured to allow the author to place one or more gesture clips as performance clips along a timeline of the story line, wherein the author selects the one or more gesture clips from a set of predefined gesture clips;
a look at lane that is configured to allow the author to place one or more look at clips as performance clips along a timeline of the story line, wherein the author selects the one or more look at clips from a set of predefined look at clips; and
an energy lane that is configured to allow the author to place one or more energy clips as performance clips along a timeline of the story line, wherein the author selects the one or more energy clips from a set of predefined energy clips.

3. The non-transitory machine-readable medium storing a performance editing application of claim 2, wherein each of the 3D virtual characters have an emotional state, wherein the application is configured to allow the emotional state of the one or more 3D virtual characters to affect one or more of the following: a speech synthesis output, one or more facial expressions, one or more gestures, one or more poses, and an idle behavior of the one or more 3D virtual characters.

4. The non-transitory machine-readable medium storing a performance editing application of claim 2 or 3 wherein the emotion lane is configured to allow a persistent transition from a current emotional state of the one or more 3D virtual characters to a destination emotional state at one or more time periods of the story line.

5. The non-transitory machine-readable medium storing a performance editing application of any of claims 2 to 4, wherein each of the 3D virtual characters have a gesture state, wherein the application is configured to allow a gesture state of the one or more 3D virtual characters to affect one or more of the following: a face, a head, an upper body, a hand, an arm, a foot, and a lower body part of the one or more 3D virtual characters.

6. The non-transitory machine-readable medium storing a performance editing application of any of claims 2 to 5, wherein the gesture lane is configured to allow a persistent transition from a current gesture state of the one or more 3D virtual characters to a destination gesture state of the one or more 3D virtual characters at one or more time periods of the story line.

7. The non-transitory machine-readable medium storing a performance editing application of any of claims 2 to 6, wherein a predefined gesture clip in the set of predefined gesture clips includes instructions to the one or more 3D virtual characters as to where to look when performing a gesture associated with the predefined gesture clip.

8. The non-transitory machine-readable medium storing a performance editing application of any of claims 2 to 7, wherein each of the 3D virtual characters have an energy state, wherein the application is configured to allow an energy state of the one or more 3D virtual characters to affect one or more of the following: the one or more body poses, the one or more gestures, the speech synthesis output, and the idle behavior of the one or more 3D virtual characters.

9. The non-transitory machine-readable medium storing a performance editing application of any of claims 2 to 8, wherein the application's energy lane is configured to allow a persistent transition from a current energy state of the one or more 3D virtual characters to a destination energy state of the one or more 3D virtual characters at one or more time periods of the story line.

10. The non-transitory machine-readable medium storing a performance editing application of any of claims 1 to 9, wherein the application is configured to allow the author to insert one or more smart clips at one or more time periods of the story line, a smart clip comprising self-contained or substantially self-contained instructions and/or visual data to direct the visual performance of one or more 3D virtual character.

11. The non-transitory machine-readable medium storing a performance editing application of claim 10, wherein the one or more smart clips are configured to be used to change the 3D virtual character performance in real time with respect to one or more of the following: an emotional state, a body pose, an energy state, and a body gesture.

12. The non-transitory machine-readable medium storing a performance editing application of claim 10 or 11, wherein the application is configured to automatically allow one or more smart clips to be triggered in real time based at least in part on the one or more human end users input.

13. The non-transitory machine-readable medium storing a performance editing application of claim 12, wherein the one or more human end users input includes one or more of the following: speech emotion, heart-rate, blood pressure, eye pupil motion and dilation, and temperature.

14. The non-transitory machine-readable medium storing a performance editing application of any of claims 1 to 13, wherein the application is configured to allow the author the ability to alter the placement along the time line of the story line of one or more of the following: the one or more conversational dialog clips, the one or more emotion clips, the one or more gesture clips, the one or more look at clips, the one or more energy clips, and the one or more smart clips.

15. The non-transitory machine-readable medium storing a performance editing application of any of claims 1 to 14, wherein the interactive narrative is in real time.

16. The non-transitory machine-readable medium storing a performance editing application of any of claims 1 to 15, wherein the animating tool is a virtual character animation engine that enables animation and/or behavior of the virtual characters.

17. A system comprising: one or more processors; and one or more memories coupled to the one or more processors comprising instructions executable by the one or more processors, the one or more processors being operable when executing the instructions to implement any of claims 1 to 16.

18. A system comprising:
one or more processors;
one or more memories coupled to the one or more processors;
a display comprising a display area and coupled to the one or processors;
a non-transitory machine-readable performance editing application stored in the one or more memories, the performance editing application is configured to allow an author to create a visual performance for one or more 3D virtual characters in a story line, the performance editing application comprising:
a first tool that is configured to allow the author to select one or more 3D virtual characters from a predefined set of virtual characters, and one or more virtual environments from a predefined set of virtual environments and add to the display area;
the display area for displaying at least in part the visual performance of one or more 3D virtual characters in the story line; and
in the display area:
defining one or more dialog lanes that are configured to allow the author to place one or more conversational dialog clips along a timeline of the story line, wherein the one or more conversational dialog clips of the one or more 3D virtual characters are selected by the author;
defining an emotion lane that is configured to allow the author to place one or more emotion clips along a timeline of the story line, wherein the author selects the one or more emotional clips from a set of predefined emotional clips;
defining a gesture lane that is configured to allow the author to place one or more gesture clips along a timeline of the story line, wherein the author selects the one or more gesture clips from a set of predefined gesture clips;
defining a look at lane that is configured to allow the author to place one or more look at clips along a timeline of the story line, wherein the author selects the one or more look at clips from a set of predefined look at clips; and/or
defining an energy lane that is configured to allow the author to place one or more energy clips along a timeline of the story line, wherein the author selects the one or more energy clips from a set of predefined energy clips; and
an animating tool that is configured to animate the one or more 3D virtual characters and the one or more virtual environments a least in part by data authored in the timeline of the story line by associating the one or more 3D virtual characters and the one or more virtual environments with data from one or more of the following: the one or more dialog lanes, the emotion lane, the gesture lane, the look at lane and the energy lane;
such that the performance editing application allows the author to create the visual components of the one or more 3D virtual characters that are capable of being used in an interactive narrative.

19. A method of using a non-transitory machine-readable medium storing a performance editing application to allow an author to create a visual performance for one or more 3D virtual characters in a story line, comprising the steps of:
using a first tool that allows the author to select one or more 3D virtual characters from a predefined set of virtual characters, and one or more virtual environments from a predefined set of virtual environments;
adding the selected one or more 3D virtual characters and the one or more virtual environments to a display area and displaying the select one or more 3D virtual characters and the one or more virtual environments in the display area;
defining one or more dialog lanes in the display area allowing the author to place one or more conversational dialog clips along a timeline of the story line, wherein the one or more conversational dialog clips of the one or more 3D virtual characters are selected by the author;
defining an emotion lane in the display area allowing the author to place one or more emotion clips along a timeline of the story line, wherein the author selects the one or more emotional clips from a set of predefined emotional clips;
defining a gesture lane in the display area allowing the author to place one or more gesture clips along a timeline of the story line, wherein the author selects the one or more gesture clips from a set of predefined gesture clips;
defining a look at lane in the display area allowing the author to place one or more look at clips along a timeline of the story line, wherein the author selects the one or more look at clips from a set of predefined look at clips; and/or
defining an energy lane in the display area allowing the author to place one or more energy clips along a timeline of the story line, wherein the author selects the one or more energy clips from a set of predefined energy clips; and
using an animating tool to animate the one or more 3D virtual characters and the one or more virtual environments a least in part by data authored in the timeline of the story line by associating the one or more 3D virtual characters and the one or more virtual environments with data from one or more of the following: the one or more dialog lanes, the emotion lane, the gesture lane, the look at lane and the energy lane;
such that the performance editing application allows the author to create the visual components of the one or more 3D virtual characters that are capable of being used in an interactive narrative.
